(19) United States
(12) Patent Application Publication
(10) Pub. No.: US 2010/0321372 A1
(43) Pub. Date: Dec. 23, 2010

(54) DISPLAY DEVICE AND METHOD FOR DRIVING DISPLAY

(76) Inventors: Akihisa Iwamoto, Osaka (JP); Hideki Morii, Osaka (JP); Takayuki Mizunaga, Osaka (JP); Yuuki Ohta, Osaka (JP); Masahiro Hirokane, Osaka (JP)

Correspondence Address: HARNESS, DICKEY & PIERCE, P.L.C., P.O. BOX 8910, RESTON, VA, 20195, US

(21) Appl. No.: 12/735,658

(22) PCT Filed: Oct. 20, 2008
(86) PCT No.: PCT/JP2008/068989

§ 371 Date: Aug. 5, 2010

(30) Foreign Application Priority Data
Feb. 19, 2008 (JP) 2008-037625

(51) Int. Cl. G09G 5/00; G09G 3/36

(52) U.S. Cl. 345/212; 345/87

(57) ABSTRACT

Each stage of first and second shift registers outputs a scan pulse by transferring a clock pulse of a clock signal supplied through a first clock input terminal. A first transistor is provided in at least one embodiment so as to connect and disconnect a scan signal line corresponding to the individual stage to and from a low-level power source of the scan pulse, and the first transistor has a gate that receives a clock signal supplied through a second clock input terminal. Two clock signals supplied to the first shift register and two clock signals supplied to the second shift register are different from each other in timings of their clock pulses. This realizes a display device capable of curbing the phenomenon in which a threshold voltage of a sink-down transistor is shifted, while sinking the gate line voltage down.

### TECHNICAL FIELD

The present invention relates to a scan signal line driving circuit of a display device.

### BACKGROUND ART

In recent years, the fabrication of a monolithic gate driver has been developed for the purpose of cost reduction. The monolithic gate driver is such a gate driver that is formed from amorphous silicon on a liquid crystal panel. The term “monolitic gate driver” is also associated with the terms such as “gate driver-free”, “built-in gate driver in panel”, and “gate in panel”. Patent Literatures 1 through 3, etc. disclose shift registers of monolithic gate drivers.

FIG. 12 shows the configuration of a shift register of a gate driver in such a liquid crystal display device with a monolithic gate driver.

As shown in FIG. 12, the gate driver includes a shift register 501. The shift register 501 is provided in one region adjoining a display region 200a, which is an active area of a display panel, along a direction in which gate lines G1, G2, and the like extend.

The shift register 501 includes a plurality of shift register stages sr (sr1, sr2, . . . ) which are cascaded with each other. Each of the shift register stages sr includes a set input terminal Qn−1, an output terminal GOUT, a reset input terminal Qn+1, clock input terminals CKA and CKB, and a Low power source input terminal VSS.

An output from an output terminal GOUT of an i-th (i=1, 2, . . . ) shift register stage sri is a gate output Gi to be outputted to an i-th gate line.

To a set input terminal Qn−1 of a first shift register stage sr1, a gate start pulse GSP1 is supplied. To respective set input terminals Qn−1 of second and succeeding shift register stages sri, gate outputs Gi−1 of their preceding shift register stages sri−1 are supplied. Further, to respective reset input terminals Qn+1 of the shift register stages sri, gate outputs Gi+1 of their subsequent shift register stages sri+1 are supplied.

To one of the clock input terminals CKA and CKB, a clock signal CK1 is supplied, and to the other clock input terminal, a clock signal CK2 is supplied. In this manner, destination terminals of the clock signals CK1 and CK2 are reversed between the adjacent shift register stages sr. Here, for the odd-numbered shift register stages sri (i=1, 3, 5, . . . ), clock signals CK1 and CK2 are supplied to the clock input terminals CKA and CKB, respectively. For the even-numbered shift register stages sri (i=2, 4, 6, . . . ), clock signals CK2 and CK1 are supplied to the clock input terminals CKA and CKB, respectively. The clock signals CK1 and CK2 have such phases that their clock pulses do not overlap each other, as shown in FIG. 14, for example.

Thus, the shift register 501 is driven in a double-phase clock.

FIG. 13 shows an exemplary configuration of the shift register stage sr.

The shift register stage sr shown in FIG. 13 is described in Patent Literature 1. Reference signs RS(1), RS(2), RS(3) . . . each corresponds to the shift register stage sr and each includes n-channel type TFTs 21, 22, 23, 24. A gate and drain of the diode-connected TFT 21 correspond to the set input terminal Qn−1, a gate of the TFT 23 corresponds to the reset input terminal Qn+1, a drain of the TFT 22 corresponds to the clock input terminal CKA, a gate of the TFT 24 corresponds to the clock input terminal CKB, output signals OUT (OUT1, OUT2, . . . ) each corresponds to the gate output Gi, Pst corresponds to the gate start pulse GSP1, and each source of the TFTs 23 and 24 corresponds to the Low power source input terminal VSS.

FIG. 14 shows operations of a shift register that includes the shift register stage sr configured as shown in FIG. 13.

A period indicated by 1T is one line period, a selection period of each gate line is within 1T. A period indicated by 1F is one frame period. The clock signals CK1 and CK2 have such phases that their clock pulses (high level periods) do not overlap each other.

In the shift register stage RS(1), when the gate start pulse Pst is supplied to the gate and drain of the TFT 21, the TFT 21 is turned ON, and interconnect capacitance Ca (Ca(1) in FIG. 14) becomes charged. When the supply of the gate start pulse Pst is completed, the TFT 21 is turned OFF. The interconnect capacitance Ca is a capacitance formed on an interconnection that connects a source of the TFT 21, a gate of the TFT 22, and a drain of the TFT 23. Charging of the interconnect capacitance Ca causes the TFT 22 to be turned ON, and the clock signal CK1 is outputted as an output signal OUT1. At this moment, a gate potential of the TFT 22 is pumped up due to a bootstrap effect, and the clock signal CK1 is thus outputted as the output signal OUT1 with a sharp rising edge.

Next, in the shift register stage RS(2), the output signal OUT1 from the shift register stage RS(1) is supplied to the gate and drain of the TFT 21, and the shift register stage RS(2) performs operations similar to the operations of the shift register stage RS(1). At this moment, as the output signal OUT2 from the shift register stage RS(2), the clock signal CK2 is outputted. Further, a pulse of the output signal OUT2, which corresponds to a clock pulse of the clock signal CK2, is supplied to a gate of the TFT 23 of the shift register stage RS(1). This causes the TFT 23 to be turned ON, and the interconnect capacitance Ca of the shift register stage RS(1) discharges when an Low power source voltage Vss is supplied to each source of the TFTs 23 and 24.

From the subsequent shift register stages RS, clock pulses are sequentially outputted as the output signals OUT3, OUT4, and the like. As the output signals OUT1, OUT3, . . . from the odd-numbered stages, the clock pulse of the clock signal CK1 is outputted. As the output signals OUT2, OUT4, . . . from the even-numbered stages, the clock pulse of the clock signal CK2 is outputted.

Further, the clock pulse of the clock signal CK2 is supplied to the gates of the TFTs 24 of the odd-numbered shift register stages RS(1), RS(3), and the like, and the clock pulse of the clock signal CK1 is supplied to the gates of the respective TFTs 24 of the even-numbered shift register stages RS(2), RS(4), and the like. With this arrangement, each of the TFTs 24 is turned ON every time it receives the clock pulse, and a voltage of a gate line during the period where each of the TFTs 24 is turned ON is fixed to a Low voltage Vss. This operation is called “sinking the gate line voltage down”.

Patent Literature 1

Japanese Patent Application Publication, Tokukai, No. 2001-273785 A (Publication Date: Oct. 5, 2001)

Patent Literature 2

Japanese Patent Application Publication, Tokukai, No. 2006-24350 A (Publication Date: Jan. 26, 2006)

Patent Literature 3

Japanese Patent Application Publication, Tokukai, No. 2007-114771 A (Publication Date: May 10, 2007)

### SUMMARY OF INVENTION

However, like the liquid crystal display devices disclosed in Patent Literatures 1 through 3, the conventional liquid crystal display device with a monolitic gate driver has the following problem. That is, over a prolonged period, ON-voltage is applied to a gate of the sink-down TFT (TFT 24 in FIG. 13) that periodically fixes a voltage of the gate line to Low voltage (corresponding to Low voltage Vss in FIG. 13) outside the selection period of the gate line. This shifts a threshold voltage of the TFT concerned. Since the n-channel type TFT is used in the above liquid crystal display device with a monolitic gate driver, the threshold voltage shifts upwards. In the example shown in FIG. 14, as is clear from the waveforms of the clock signals CK1 and CK2, “ON” duty cycle of the sink-down TFT is nearly 50%. This causes a serious shift of the threshold voltage.

As is clear from the waveforms of the clock signals CK1 and CK2 in FIG. 14, the “sinking” is also partially made by Low voltages of the clock signals CK1 and CK2 during a period in which the clock signals CK1 and CK2 are outputted as the output signals OUT. However, at the time of occurrence of the foregoing phenomenon in which the threshold voltage of the TFT is shifted, the sink-down TFT is insufficiently turned ON. This makes it difficult to reliably sink the gate line voltage down. During an OFF period of the sink-down TFT outside the selection period of the gate line, the gate line becomes floating. If such a floating period is long, a potential of the gate line may deviate from a potential that ensures a selection element of a pixel to be turned OFF, when noise propagates to the gate line from a source line, etc. Therefore, it is desirable to ensure the sink-down TFT to be turned ON so that the potential of the gate line is normally and periodically fixed to Low voltage.

The present invention has been attained in view of the problem caused by the conventional technique, and an object of the present invention is to realize: a display device capable of curbing the occurrence of the phenomenon in which a threshold voltage of a sink-down transistor is shifted, while sinking the gate line voltage down; and a method for driving the display device.

In order to solve the above problem, a display device according to the present invention is a display device comprising an active matrix panel, the display device further comprising: a first scan signal line driving circuit; and a second scan signal line driving circuit, wherein of all scan signal lines wherein of all scan signal lines consisting of (i) a first group of scan signal lines connected to the first scan signal line driving circuit and (ii) a second group of scan signal lines connected to the second scan signal line driving circuit, the scan signal lines in the first group and the scan signal lines in the second group are disposed in an alternate manner, the first scan signal line driving circuit including a first shift register which receives two clock signals that are first and second clock signals, the first shift register having stages each of which includes first and second clock input terminals, the first shift register being arranged to have first stages and second stages alternately cascaded with each other, each of the first stages being such that the first clock signal is supplied to the first clock input terminal, and the second clock signal is supplied to the second clock input terminal, each of the second stages being such that the second clock signal is supplied to the first clock input terminal, and the first clock signal is supplied to the second clock input terminal, the stages of the first shift register, upon receipt of a shift pulse from a preceding stage, each outputting a scan pulse by transferring a clock pulse of a clock signal supplied through the first clock input terminal to a scan signal line corresponding to the individual stage, the stages of the first shift register each including a first transistor that is provided so as to connect and disconnect a scan signal line corresponding to the individual stage to and from a low-level power source of the scan pulse, the first transistor having a gate receiving a clock signal supplied through the second clock input terminal, the second scan signal line driving circuit including a second shift register which receives two clock signals that are third and fourth clock signals, the second shift register having stages each of which includes third and fourth clock input terminals, the second shift register being arranged to have third stages and fourth stages alternately cascaded with each other, each of the third stages being such that the third clock signal is supplied to the third clock input terminal, and the fourth clock signal is supplied to the fourth clock input terminal, each of the fourth stages being such that the fourth clock signal is supplied to the third clock input terminal, and the third clock signal is supplied to the fourth clock input terminal, the stages of the second shift register, upon receipt of a shift pulse from a preceding stage, each outputting a scan pulse by transferring a clock pulse of a clock signal supplied through the third clock input terminal to a scan signal line corresponding to the individual stage, the stages of the second shift register each including a second transistor that is provided so as to connect and disconnect a scan signal line corresponding to the individual stage to and from a low-level power source of the scan pulse, the second transistor having a gate receiving a clock signal supplied through the fourth clock input terminal, wherein timings for the first clock signal, the second clock signal, the third clock signal, and the fourth clock signal are such that a clock pulse of the first clock signal appears subsequently to a clock pulse of the fourth clock signal, a clock pulse of the third clock signal appears subsequently to a clock pulse of the first clock signal, a clock pulse of the second clock signal appears subsequently to the clock pulse of the third clock signal, and the clock pulse of the fourth clock signal appears subsequently to the clock pulse of the second clock signal.

According to the above invention, the scan signal lines are driven by two different scan signal line driving circuits in an alternate manner. Therefore, when compared with the frequency required under the circumstance where the scan signal lines are all driven by a single scan signal line driving circuit, only a half of the frequency is necessary for each stage of the first and second shift registers to (i) output a scan pulse to a scan signal line by transferring one of the two clock signals and to (ii) to set the scan signal line to a potential of a low-level power source outside the selection period by transferring the other clock signal, i.e. to sink the scan signal line voltage down. Since the timings for the clock pulses of the first through fourth clock signals are defined as described previously, appropriate setting of a gate start pulse for each of the scan signal line driving circuits enables the two different scan signal lines to perform sequential scanning of all of the scan signal lines.

Therefore, it is possible to reduce “ON” duty cycle of a clock pulse to be applied to the gate of the first transistor in each stage of the first shift register and to the gate of the second transistor in each stage of the second shift register, to about half of “ON” duty cycle of a clock pulse in the conventional display device. This makes it possible to curb the occurrence of the phenomenon in which the threshold voltage of the sink-down transistor is shifted.

The above arrangement yields the effect of realizing a display device capable of curbing the occurrence of the phenomenon in which the threshold voltage of the sink-down transistor is shifted, while sinking the gate line voltage down.

In order to solve the above problem, a display device according to the present invention is a display device comprising an active matrix panel, the display device further comprising: a first scan signal line driving circuit; and a second scan signal line driving circuit, wherein of all scan signal lines consisting of (i) a first group of scan signal lines connected to the first scan signal line driving circuit and (ii) a second group of scan signal lines connected to the second scan signal line driving circuit, the scan signal lines in the first group and the scan signal lines in the second group are disposed in an alternate manner, the first scan signal line driving circuit including a first shift register which receives four clock signals that are first, second, and third, fourth clock signals, the first shift register having stages each of which includes first, second, third, and fourth clock input terminals, the first shift register being arranged to have first stages and second stages alternately cascaded with each other, each of the first stages being such that the first clock signal is supplied to the first clock input terminal, the second clock signal is supplied to the second clock input terminal, the third clock signal is supplied to the third clock input terminal, and the fourth clock signal is supplied to the fourth clock input terminal, each of the second stages being such that the second clock signal is supplied to the first clock input terminal, the first clock signal is supplied to the second clock input terminal, the fourth clock signal is supplied to the third clock input terminal, and the third clock signal is supplied to the fourth clock input terminal, the stages of the first shift register, upon receipt of a shift pulse from a preceding stage, each outputting a scan pulse by transferring a clock pulse of a clock signal supplied through the first clock input terminal to a scan signal line corresponding to the individual stage, the stages of the first shift register each including: a first transistor that is provided so as to connect and disconnect a scan signal line corresponding to the individual stage to and from a low-level power source of the scan pulse, the first transistor having a gate receiving a clock signal supplied through the second clock input terminal; a second transistor that is provided so as to connect and disconnect the scan signal line corresponding to the individual stage to and from the low-level power source, the second transistor having a gate to which a clock pulse of a clock signal supplied through the third clock input terminal is applied; and a third transistor that is provided so as to connect and disconnect the scan signal line corresponding to the individual stage to and from the low-level power source, the third transistor having a gate to which a clock pulse of a clock signal supplied through the fourth clock input terminal is applied, the second scan signal line driving circuit including a second shift register which receives the four clock signals that are the first, second, and third, fourth clock signals, the second shift register having stages each of which includes fifth, sixth, seventh, and eighth clock input terminals, the second shift register being arranged to have third stages and fourth stages alternately cascaded with each other, each of the third stages being such that the third clock signal is supplied to the fifth clock input terminal, the fourth clock signal is supplied to the sixth clock input terminal, the first clock signal is supplied to the seventh clock input terminal, and the second clock signal is supplied to the eighth clock input terminal, each of the fourth stages being such that the fourth clock signal is supplied to the fifth clock input terminal, the third clock signal is supplied to the sixth clock input terminal, the second clock signal is supplied to the seventh clock input terminal, and the first clock signal is supplied to the eighth clock input terminal, the stages of the second shift register, upon receipt of a shift pulse from a preceding stage, each outputting a scan pulse by transferring a clock pulse of a clock signal supplied through the fifth clock input terminal to a scan signal line corresponding to the individual stage, the stages of the second shift register each including: a fourth transistor that is provided so as to connect and disconnect a scan signal line corresponding to the individual stage to and from a low-level power source of the scan pulse, the fourth transistor having a gate receiving a clock signal supplied through the sixth clock input terminal; a fifth transistor that is provided so as to connect and disconnect the scan signal line corresponding to the individual stage to and from the low-level power source, the fifth transistor having a gate to which a clock pulse of a clock signal supplied through the seventh clock input terminal is applied; and a sixth transistor that is provided so as to connect and disconnect the scan signal line corresponding to the individual stage to and from the low-level power source, the sixth transistor having a gate to which a clock pulse of a clock signal supplied through the eighth clock input terminal is applied, wherein timings for the first clock signal, the second clock signal, the third clock signal, and the fourth clock signal are such that a clock pulse of the first clock signal appears subsequently to a clock pulse of the fourth clock signal, a clock pulse of the third clock signal appears subsequently to a clock pulse of the first clock signal, a clock pulse of the second clock signal appears subsequently to the clock pulse of the third clock signal, and the clock pulse of the fourth clock signal appears subsequently to the clock pulse of the second clock signal.

According to the above invention, the scan signal lines are driven by two different scan signal line driving circuits in an alternate manner. Therefore, when compared with the frequency required under the circumstance where the scan signal lines are all driven by a single scan signal line driving circuit, only a half of the frequency is necessary for each stage of the first and second shift registers to (i) output a scan pulse to a scan signal line by transferring one clock signal and to (ii) to set the scan signal line to a potential of a low-level power source outside the selection period by transferring the other three clock signals, i.e. to sink the scan signal line voltage down. Since the timings for the clock pulses of the first through fourth clock signals are defined as described previously, appropriate setting of a gate start pulse for each of the scan signal line driving circuits enables the two different scan signal lines to perform sequential scanning of all of the scan signal lines.

Therefore, it is possible to reduce “ON” duty cycle of a clock pulse to be applied to the respective gates of the first through third transistors in each stage of the first shift register and to the respective gates of the fourth through sixth transistors in each stage of the second shift register, to about half of “ON” duty cycle of a clock pulse in the conventional display device. This makes it possible to curb the occurrence of the phenomenon in which the threshold voltage of the sink-down transistor is shifted. Further, three sink-down transistors are provided in each of the stages, and “sinking” is performed during a period in which the clock pulse is supplied to each of the three sink-down transistors. This makes it possible to realize sinking the scan signal line voltage down for a long time, and to realize further stabilization of a potential of the scan signal line outside the selection period of the scan signal line.

The above arrangement yields the effect of realizing a display device capable of curbing the occurrence of the phenomenon in which the threshold voltage of the sink-down transistor is shifted, while sinking the gate line voltage down.

In order to solve the above problem, a display device according to the present invention is such that one of the first and second scan signal line drive circuits is provided in one of two regions adjoining a display region of the panel in a direction in which the scan signal lines extend, and the other scan signal line drive circuit is provided in the other region adjoining the display region of the panel.

According to the above invention, the two scan signal line driving circuits are provided on a pair of opposite sides of the display region. Since each of the scan signal line driving circuits needs to drive only half of all of the scan signal lines, the number of stages is small in the shift register. Therefore, it is possible to realize each of the scan signal line driving circuit with a small area. This yields the effect of providing a display device with slim picture frame regions on a pair of opposite sides of the display region in the panel.

In order to solve the above problem, a display device according to the present invention is a display device comprising an active matrix panel, the display device further comprising a scan signal line driving circuit that is provided in a region adjoining a display region of the panel in a direction in which scan signal lines extend and that includes first and second shift registers connected to the scan signal lines, wherein of all of the scan signal lines consisting of (i) a first group of scan signal lines connected to the first shift register and (ii) a second group of scan signal lines connected to the second shift register, the scan signal lines in the first group and the scan signal lines in the second group are disposed in an alternate manner, the first shift register receiving two clock signals that are first and second clock signals, the first shift register having stages each of which includes first and second clock input terminals, the first shift register being arranged to have first stages and second stages alternately cascaded with each other, each of the first stages being such that the first clock signal is supplied to the first clock input terminal, and the second clock signal is supplied to the second clock input terminal, each of the second stages being such that the second clock signal is supplied to the first clock input terminal, and the first clock signal is supplied to the second clock input terminal, the stages of the first shift register, upon receipt of a shift pulse from a preceding stage, each outputting a scan pulse by transferring a clock pulse of a clock signal supplied through the first clock input terminal to a scan signal line corresponding to the individual stage, the stages of the first shift register each including a first transistor that is provided so as to connect and disconnect a scan signal line corresponding to the individual stage to and from a low-level power source of the scan pulse, the first transistor having a gate receiving a clock signal supplied through the second clock input terminal, the second shift register receiving two clock signals that are third and fourth clock signals, the second shift register having stages each of which includes third and fourth clock input terminals, the second shift register being arranged to have third stages and fourth stages alternately cascaded with each other, each of the third stages being such that the third clock signal is supplied to the third clock input terminal and that the fourth clock signal is supplied to the fourth clock input terminal, each of the fourth stages being such that the fourth clock signal is supplied to the third clock input terminal and that the third clock signal is supplied to the fourth clock input terminal, the stages of the second shift register, upon receipt of a shift pulse from a preceding stage, each outputting a scan pulse by transferring a clock pulse of a clock signal supplied through the third clock input terminal to a scan signal line corresponding to the individual stage, the stages of the second shift register each including a second transistor that is provided so as to connect and disconnect a scan signal line corresponding to the individual stage to and from a low-level power source of the scan pulse, the second transistor having a gate receiving a clock signal supplied through the fourth clock input terminal, wherein timings for the first clock signal, the second clock signal, the third clock signal, and the fourth clock signal are such that a clock pulse of the first clock signal appears subsequently to a clock pulse of the fourth clock signal, a clock pulse of the third clock signal appears subsequently to a clock pulse of the first clock signal, a clock pulse of the second clock signal appears subsequently to the clock pulse of the third clock signal, and the clock pulse of the fourth clock signal appears subsequently to the clock pulse of the second clock signal.

According to the above invention, the scan signal lines are driven by two different shift registers in an alternate manner. Therefore, when compared with the frequency required under the circumstance where the scan signal lines are all driven by a single scan signal line driving circuit, only a half of the frequency is necessary for each stage of the first and second shift registers to (i) output a scan pulse to a scan signal line by transferring one of the two clock signals and to (ii) to set the scan signal line to a potential of a low-level power source outside the selection period by transferring the other clock signal, i.e. to sink the scan signal line voltage down. Since the timings for the clock pulses of the first through fourth clock signals are defined as described previously, appropriate setting of a gate start pulse for each of the scan signal line driving circuits enables the two different scan signal lines to perform sequential scanning of all of the scan signal lines.

Therefore, it is possible to reduce “ON” duty cycle of a clock pulse to be applied to the gate of the first transistor in each stage of the first shift register and to the gate of the second transistor in each stage of the second shift register, to about half of “ON” duty cycle of a clock pulse in the conventional display device. This makes it possible to curb the occurrence of the phenomenon in which the threshold voltage of the sink-down transistor is shifted.

The above arrangement yields the effect of realizing a display device capable of curbing the occurrence of the phenomenon in which the threshold voltage of the sink-down transistor is shifted, while sinking the gate line voltage down.

In order to solve the above problem, a display device according to the present invention is such that the first and second scan signal line drive circuits are monolithically formed in the panel.

According to the above invention, it is possible to curb the occurrence of the phenomenon in which the threshold voltage of the sink-down transistor is shifted in the so-called display device with a monolithically fabricated gate driver. This yields the effect of further exploiting the advantage of a driver which is configured to realize processes performed simultaneously with the display region and size reduction of the panel.

In order to solve the above problem, a display device according to the present invention is such that the scan signal line drive circuit is monolithically formed in the panel.

According to the above invention, it is possible to curb the occurrence of the phenomenon in which the threshold voltage of the sink-down transistor is shifted in the so-called display device with a monolithically fabricated gate driver. This yields the effect of further exploiting the advantage of a driver which is configured to realize processes performed simultaneously with the display region and size reduction of the panel.

In order to solve the above problem, a display device according to the present invention is such that the panel is formed from amorphous silicon.

According to the above invention, it is possible to curb the threshold voltage shift of a sink-down transistor, even if it sinks potential of a floating spot which is liable to emerge in a shift register stage circuit with transistors only of n-type channel polarity and hence with its range of supply voltage set to be biased strongly toward one polarity side. This yields the effect of significantly improving circuit characteristics.

In order to solve the above problem, a display device according to the present invention is such that the panel is formed from polycrystalline silicon.

According to the above invention, it is possible to curb the threshold voltage shift of a sink-down transistor, even if it sinks potential of a floating spot which is liable to emerge in a shift register stage circuit with transistors only of a single polarity and hence with its range of supply voltage set to be biased strongly toward one polarity side. This yields the effect of significantly improving circuit characteristics.

In order to solve the above problem, a display device according to the present invention is such that the panel is formed from CG silicon.

According to the above invention, it is possible to curb the threshold voltage shift of a sink-down transistor, even if it sinks potential of a floating spot which is liable to emerge in a shift register stage circuit with transistors only of a single polarity and hence with its range of supply voltage set to be biased strongly toward one polarity side. This yields the effect of significantly improving circuit characteristics.

In order to solve the above problem, a display device according to the present invention is such that the panel is formed from microcrystalline silicon.

According to the above invention, it is possible to curb the threshold voltage shift of a sink-down transistor, even if it sinks potential of a floating spot which is liable to emerge in a shift register stage circuit with transistors only of a single polarity and hence with its range of supply voltage set to be biased strongly toward one polarity side. This yields the effect of significantly improving circuit characteristics.

In order to solve the above problem, a method for driving a display device according to the present invention is a method for driving a display device comprising an active matrix panel, the display device further comprising: a first scan signal line driving circuit including a first shift register; and a second scan signal line driving circuit including a second shift register, wherein of all scan signal lines consisting of (i) a first group of scan signal lines connected to the first scan signal line driving circuit and (ii) a second group of scan signal lines connected to the second scan signal line driving circuit, the scan signal lines in the first group and the scan signal lines in the second group are disposed in an alternate manner, the method comprising: supplying two clock signals that are first and second clock signals to each of stages of the first shift register; causing the stages of the first shift register to operate so that first stages and second stages are alternately arranged, each of the first stages operating to, upon receipt of a shift pulse from a preceding stage, output a scan pulse by transferring a clock pulse of the first clock signal to a scan signal line corresponding to the individual stage, each of the second stages operating to, upon receipt of a shift pulse from a preceding stage, output a scan pulse by transferring a clock pulse of the second clock signal to a scan signal line corresponding to the individual stage; causing each of the first stages to connect and disconnect a scan signal line corresponding to the individual stage to and from a low-level power source of the scan pulse, when the second clock signal is supplied to a gate of a transistor provided in each of the first stages; causing each of the second stages to connect and disconnect a scan signal line corresponding to the individual stage to and from a low-level power source of the scan pulse, when the first clock signal is supplied to a gate of a transistor provided in each of the second stages; supplying two clock signals that are third and fourth clock signals to each of stages of the second shift register; causing the stages of the second shift register to operate so that third stages and fourth stages are alternately arranged, each of the third stages operating to, upon receipt of a shift pulse from a preceding stage, output a scan pulse by transferring a clock pulse of the third clock signal to a scan signal line corresponding to the individual stage, each of the fourth stages operating to, upon receipt of a shift pulse from a preceding stage, output a scan pulse by transferring a clock pulse of the fourth clock signal to a scan signal line corresponding to the individual stage; causing each of the third stages to connect and disconnect a scan signal line corresponding to the individual stage to and from a low-level power source of the scan pulse, when the fourth clock signal is supplied to a gate of a transistor provided in each of the third stages; and causing each of the fourth stages to connect and disconnect a scan signal line corresponding to the individual stage to and from a low-level power source of the scan pulse, when the third clock signal is supplied to a gate of a transistor provided in each of the fourth stages, wherein timings for the first clock signal, the second clock signal, the third clock signal, and the fourth clock signal are such that the clock pulse of the first clock signal appears subsequently to the clock pulse of the fourth clock signal, the clock pulse of the third clock signal appears subsequently to the clock pulse of the first clock signal, the clock pulse of the second clock signal appears subsequently to the clock pulse of the third clock signal, and the clock pulse of the fourth clock signal appears subsequently to the clock pulse of the second clock signal.

According to the above invention, the scan signal lines are driven by two different scan signal line driving circuits in an alternate manner. Therefore, when compared with the frequency required under the circumstance where the scan signal lines are all driven by a single scan signal line driving circuit, only a half of the frequency is necessary for each stage of the first and second shift registers to (i) output a scan pulse to a scan signal line by transferring one of the two clock signals and to (ii) to set the scan signal line to a potential of a low-level power source outside the selection period by transferring the other clock signal, i.e. to sink the scan signal line voltage down. Since the timings for the clock pulses of the first through fourth clock signals are defined as described previously, appropriate setting of a gate start pulse for each of the scan signal line driving circuits enables the two different scan signal lines to perform sequential scanning of all of the scan signal lines.

Therefore, it is possible to reduce “ON” duty cycle of a clock pulse to be applied to the gate of the first transistor in each stage of the first shift register and to the gate of the second transistor in each stage of the second shift register, to about half of “ON” duty cycle of a clock pulse in the conventional display device. This makes it possible to curb the occurrence of the phenomenon in which the threshold voltage of the sink-down transistor is shifted.

The above arrangement yields the effect of realizing a method for driving a display device capable of curbing the occurrence of the phenomenon in which the threshold voltage of the sink-down transistor is shifted, while sinking the gate line voltage down.

In order to solve the above problem, a method for driving a display device according to the present invention is a method for driving a display device comprising an active matrix panel, the display device further comprising: a first scan signal line driving circuit including a first shift register; and a second scan signal line driving circuit including a second shift register, wherein of all scan signal lines consisting of (i) a first group of scan signal lines connected to the first scan signal line driving circuit and (ii) a second group of scan signal lines connected to the second scan signal line driving circuit, the scan signal lines in the first group and the scan signal lines in the second group are disposed in an alternate manner, the method comprising: supplying four clock signals that are first, second, third, and fourth clock signals to each of stages of the first shift register; causing the stages of the first shift register to operate so that first stages and second stages are alternately arranged, each of the first stages operating to, upon receipt of a shift pulse from a preceding stage, output a scan pulse by transferring a clock pulse of the first clock signal to a scan signal line corresponding to the individual stage, each of the second stages operating to, upon receipt of a shift pulse from a preceding stage, output a scan pulse by transferring a clock pulse of the second clock signal to a scan signal line corresponding to the individual stage; causing each of the first stages to connect and disconnect a scan signal line corresponding to the individual stage to and from a low-level power source of the scan pulse, when the second, third, or fourth clock signal is supplied to each gate of three transistors provided in each of the first stages; causing each of the second stages to connect and disconnect a scan signal line corresponding to the individual stage to and from a low-level power source of the scan pulse, when the first, third, or fourth clock signal is supplied to each gate of three transistors provided in each of the second stages; supplying four clock signals that are the first, second, third, and fourth clock signals to each of stages of the second shift register; causing the stages of the second shift register to operate so that third stages and fourth stages are alternately arranged, each of the third stages operating to, upon receipt of a shift pulse from a preceding stage, output a scan pulse by transferring a clock pulse of the third clock signal to a scan signal line corresponding to the individual stage, each of the fourth stages operating to, upon receipt of a shift pulse from a preceding stage, output a scan pulse by transferring a clock pulse of the fourth clock signal to a scan signal line corresponding to the individual stage; causing each of the third stages to connect and disconnect a scan signal line corresponding to the individual stage to and from a low-level power source of the scan pulse, when the first, second, or fourth clock signal is supplied to each gate of three transistors provided in each of the third stages; and causing each of the fourth stages to connect and disconnect a scan signal line corresponding to the individual stage to and from a low-level power source of the scan pulse, when the first, second, or third clock signal is supplied to each gate of three transistors provided in each of the fourth stages, wherein timings for the first clock signal, the second clock signal, the third clock signal, and the fourth clock signal are such that the clock pulse of the first clock signal appears subsequently to the clock pulse of the fourth clock signal, the clock pulse of the third clock signal appears subsequently to the clock pulse of the first clock signal, the clock pulse of the second clock signal appears subsequently to the clock pulse of the third clock signal, and the clock pulse of the fourth clock signal appears subsequently to the clock pulse of the second clock signal.

According to the above invention, the scan signal lines are driven by two different scan signal line driving circuits in an alternate manner. Therefore, when compared with the frequency required under the circumstance where the scan signal lines are all driven by a single scan signal line driving circuit, only a half of the frequency is necessary for each stage of the first and second shift registers to (i) output a scan pulse to a scan signal line by transferring one of the two clock signals and to (ii) to set the scan signal line to a potential of a low-level power source outside the selection period by transferring the other clock signal, i.e. to sink the scan signal line voltage down. Since the timings for the clock pulses of the first through fourth clock signals are defined as described previously, appropriate setting of a gate start pulse for each of the scan signal line driving circuits enables the two different scan signal lines to perform sequential scanning of all of the scan signal lines.

Therefore, it is possible to reduce “ON” duty cycle of a clock pulse to be applied to the respective gates of the first through third transistors in each stage of the first shift register and to the respective gates of the fourth through sixth transistors in each stage of the second shift register, to about half of “ON” duty cycle of a clock pulse in the conventional display device. This makes it possible to curb the occurrence of the phenomenon in which the threshold voltage of the sink-down transistor is shifted. Further, three sink-down transistors are provided in each of the stages, and “sinking” is performed during a period in which the clock pulse is supplied to each of the three sink-down transistors. This makes it possible to realize sinking the scan signal line voltage down for a long time, and to realize further stabilization of a potential of the scan signal line outside the selection period of the scan signal line.

The above arrangement yields the effect of realizing a method for driving a display device capable of curbing the occurrence of the phenomenon in which the threshold voltage of the sink-down transistor is shifted, while sinking the gate line voltage down.

In order to solve the above problem, a method for driving a display device according to the present invention is such that one of the first and second scan signal line drive circuits is provided in one of two regions adjoining a display region of the panel in a direction in which the scan signal lines extend, and the other scan signal line drive circuit is provided in the other region adjoining the display region of the panel.

According to the above invention, the two scan signal line driving circuits are provided on a pair of opposite sides of the display region. Since each of the scan signal line driving circuits needs to drive only half of all of the scan signal lines, the number of stages is small in the shift register. Therefore, it is possible to realize each of the scan signal line driving circuit with a small area. This yields the effect of excellently driving a display device with slim picture frame regions on a pair of opposite sides of the display region in the panel.

In order to solve the above problem, a method for driving a display device according to the present invention is a method for driving a display device comprising an active matrix panel, the display device further comprising a scan signal line driving circuit that is provided in a region adjoining a display region of the panel in a direction in which scan signal lines extend and that includes first and second shift registers connected to the scan signal lines, wherein of all of the scan signal lines consisting of (i) a first group of scan signal lines connected to the first shift register and (ii) a second group of scan signal lines connected to the second shift register, the scan signal lines in the first group and the scan signal lines in the second group are disposed in an alternate manner, the method comprising: supplying two clock signals that are first and second clock signals to each of stages of the first shift register; causing the stages of the first shift register to operate so that first stages and second stages are alternately arranged, each of the first stages operating to, upon receipt of a shift pulse from a preceding stage, output a scan pulse by transferring a clock pulse of the first clock signal to a scan signal line corresponding to the individual stage, each of the second stages operating to, upon receipt of a shift pulse from a preceding stage, output a scan pulse by transferring a clock pulse of the second clock signal to a scan signal line corresponding to the individual stage; causing each of the first stages to connect and disconnect a scan signal line corresponding to the individual stage to and from a low-level power source of the scan pulse, when the second clock signal is supplied to a gate of a transistor provided in each of the first stages; causing each of the second stages to connect and disconnect a scan signal line corresponding to the individual stage to and from a low-level power source of the scan pulse, when the first clock signal is supplied to a gate of a transistor provided in each of the second stages; supplying two clock signals that are third and fourth clock signals to each of stages of the second shift register; causing the stages of the second shift register to operate so that third stages and fourth stages are alternately arranged, each of the third stages operating to, upon receipt of a shift pulse from a preceding stage, output a scan pulse by transferring a clock pulse of the third clock signal to a scan signal line corresponding to the individual stage, each of the fourth stages operating to, upon receipt of a shift pulse from a preceding stage, output a scan pulse by transferring a clock pulse of the fourth clock signal to a scan signal line corresponding to the individual stage; causing each of the third stages to connect and disconnect a scan signal line corresponding to the individual stage to and from a low-level power source of the scan pulse, when the fourth clock signal is supplied to a gate of a transistor provided in each of the third stages; and causing each of the fourth stages to connect and disconnect a scan signal line corresponding to the individual stage to and from a low-level power source of the scan pulse, when the third clock signal is supplied to a gate of a transistor provided in each of the fourth stages, wherein timings for the first clock signal, the second clock signal, the third clock signal, and the fourth clock signal are such that the clock pulse of the first clock signal appears subsequently to the clock pulse of the fourth clock signal, the clock pulse of the third clock signal appears subsequently to the clock pulse of the first clock signal, the clock pulse of the second clock signal appears subsequently to the clock pulse of the third clock signal, and the clock pulse of the fourth clock signal appears subsequently to the clock pulse of the second clock signal.

According to the above invention, the scan signal lines are driven by two different shift registers in an alternate manner. Therefore, when compared with the frequency required under the circumstance where the scan signal lines are all driven by a single scan signal line driving circuit, only a half of the frequency is necessary for each stage of the first and second shift registers to (i) output a scan pulse to a scan signal line by transferring one of the two clock signals and to (ii) to set the scan signal line to a potential of a low-level power source outside the selection period by transferring the other clock signal, i.e. to sink the scan signal line voltage down. Since the timings for the clock pulses of the first through fourth clock signals are defined as described previously, appropriate setting of a gate start pulse for each of the scan signal line driving circuits enables the two different scan signal lines to perform sequential scanning of all of the scan signal lines.

Therefore, it is possible to reduce “ON” duty cycle of a clock pulse to be applied to the gate of the first transistor in each stage of the first shift register and to the gate of the second transistor in each stage of the second shift register, to about half of “ON” duty cycle of a clock pulse in the conventional display device. This makes it possible to curb the occurrence of the phenomenon in which the threshold voltage of the sink-down transistor is shifted.

The above arrangement yields the effect of realizing a method for driving a display device capable of curbing the occurrence of the phenomenon in which the threshold voltage of the sink-down transistor is shifted, while sinking the gate line voltage down.

In order to solve the above problem, a method for driving a display device according to the present invention is such that the first and second scan signal line drive circuits are monolithically formed in the panel.

According to the above invention, it is possible to curb the occurrence of the phenomenon in which the threshold voltage of the sink-down transistor is shifted in the so-called display device with a monolithically fabricated gate driver. This yields the effect of further exploiting the advantage of a driver which is configured to realize processes performed simultaneously with the display region and size reduction of the panel.

In order to solve the above problem, a method for driving a display device according to the present invention is such that the scan signal line drive circuit is monolithically formed in the panel.

According to the above invention, it is possible to curb the occurrence of the phenomenon in which the threshold voltage of the sink-down transistor is shifted in the so-called display device with a monolithically fabricated gate driver. This yields the effect of further exploiting the advantage of a driver which is configured to realize processes performed simultaneously with the display region and size reduction of the panel.

In order to solve the above problem, a method for driving a display device according to the present invention is such that the panel is formed from amorphous silicon.

According to the above invention, it is possible to curb the threshold voltage shift of a sink-down transistor, even if it sinks potential of a floating spot which is liable to emerge in a shift register stage circuit with transistors only of n-type channel polarity and hence with its range of supply voltage set to be biased strongly toward one polarity side. This yields the effect of significantly improving circuit characteristics.

In order to solve the above problem, a method for driving a display device according to the present invention is such that the panel is formed from polycrystalline silicon.

According to the above invention, it is possible to curb the threshold voltage shift of a sink-down transistor, even if it sinks potential of a floating spot which is liable to emerge in a shift register stage circuit with transistors only of a single polarity and hence with its range of supply voltage set to be biased strongly toward one polarity side. This yields the effect of significantly improving circuit characteristics.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a view showing an embodiment of the present invention and an explanatory view of a first display device, wherein (a) of FIG. 1 shows a circuit diagram of the configuration of a shift register stage of the first display device, and (b) of FIG. 1 is a timing chart showing the operations of the circuit shown in (a) of FIG. 1.

FIG. 2 is a timing chart showing the operations of the first display device.

FIG. 3 is a block diagram showing the configuration of a gate driver in the first display device.

FIG. 4 is a view showing an embodiment of the present invention and a block diagram showing the configuration of a gate driver in a second display device.

FIG. 5 is an explanatory view of a shift register stage of the second display device, wherein (a) of FIG. 5 is a circuit diagram of the configuration of a shift register stage of the second display device, and (b) of FIG. 5 is a timing chart showing the operations of the circuit shown in (a) of FIG. 5.

FIG. 6 is a timing chart showing the operations of the second display device.

FIG. 7 is a view showing an embodiment of the present invention and a block diagram showing the configuration of a gate driver in a third display device.

FIG. 8 is an explanatory view of a shift register stage of the third display device, wherein (a) of FIG. 8 is a circuit diagram of the configuration of a shift register stage of the third display device, and (b) of FIG. 8 is a timing chart showing the operations of the circuit shown in (a) of FIG. 8.

FIG. 9 is a timing chart showing the operations of the third display device.

FIG. 10 is a block diagram showing the configuration of the first and second display devices.

FIG. 11 is a block diagram showing the configuration of the third display device.

FIG. 12 is a view showing the conventional configuration and a block diagram showing the configuration of a gate driver of a display device.

FIG. 13 is a view showing the conventional configuration and a circuit diagram showing the configuration of a shift register of the gate driver.

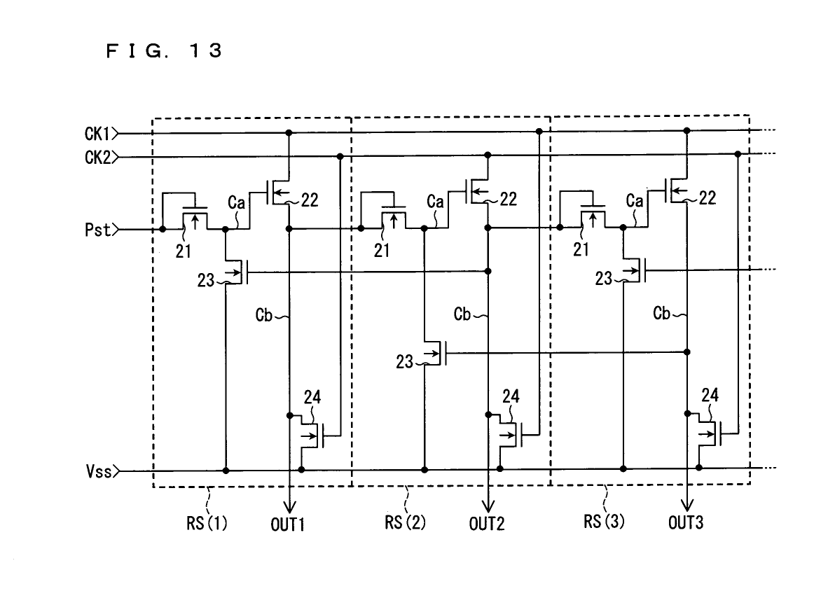

FIG. 14 is a timing chart showing the operations of the shift register shown in FIG. 13.

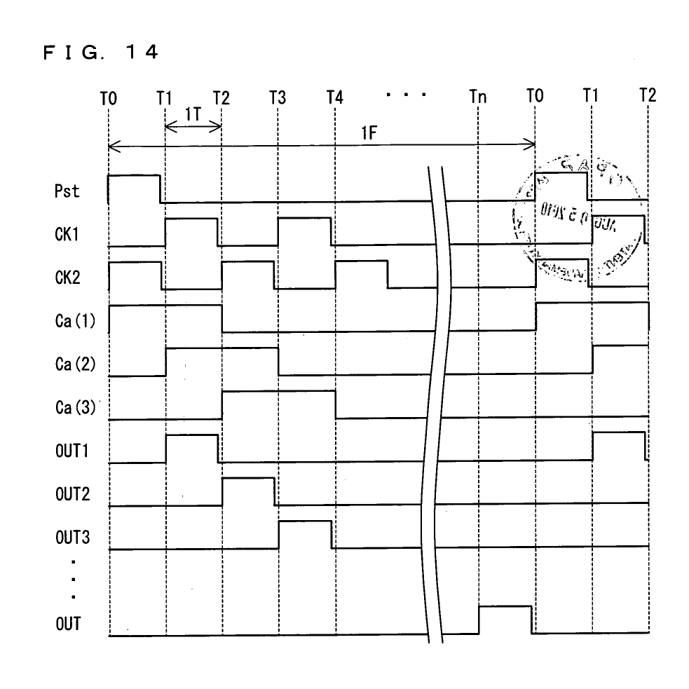

### REFERENCE SIGNS LIST

1, 11 liquid crystal display device (display device)
5a gate driver (first scan signal line driving circuit)
5b gate driver (second scan signal line driving circuit)
15 gate driver (scan signal line driving circuit)
51a first shift register
51b second shift register
52a first shift register
52b second shift register
151a first shift register
151b second shift register
GL1 to GLn gate lines (scan signal lines)
CK1 clock signal (first clock signal)
CK2 clock signal (second clock signal)
CK3 clock signal (third clock signal)
CK4 clock signal (fourth clock signal)
CKA clock input terminal (first clock input terminal)
CKB clock input terminal (second clock input terminal)
CKC clock input terminal (third clock input terminal)
CKD clock input terminal (fourth clock input terminal)
Tr2 transistors (first, second, fourth transistors)
Tr5 transistors (second and fifth transistors)
Tr6 transistors (third and sixth transistors)

### DESCRIPTION OF EMBODIMENTS

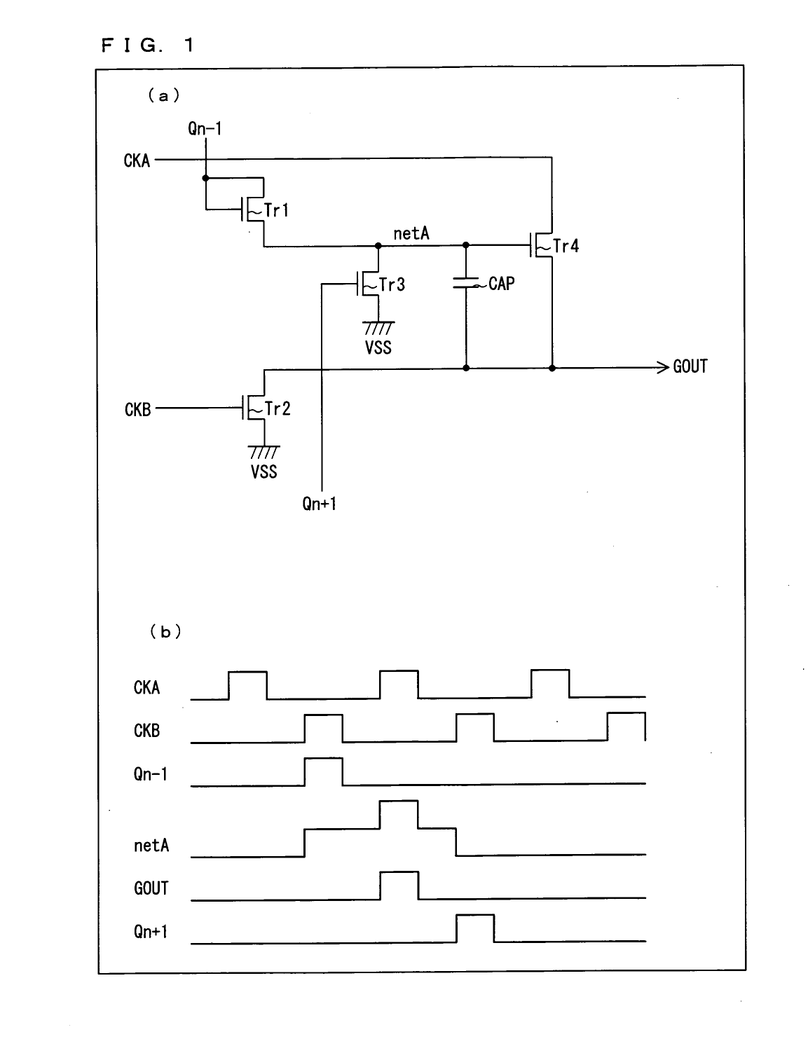

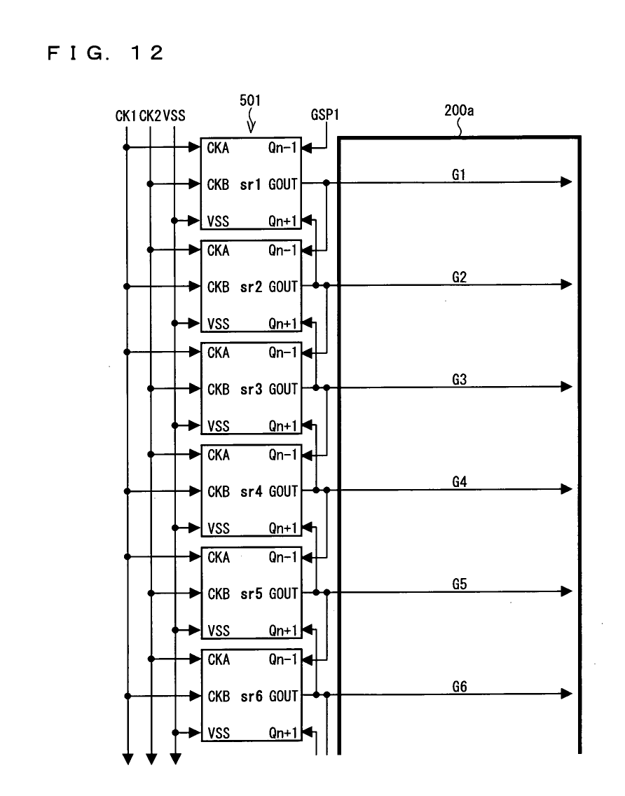

The following will describe one embodiment of the present invention with reference to FIGS. 1 through 12.

### First Embodiment

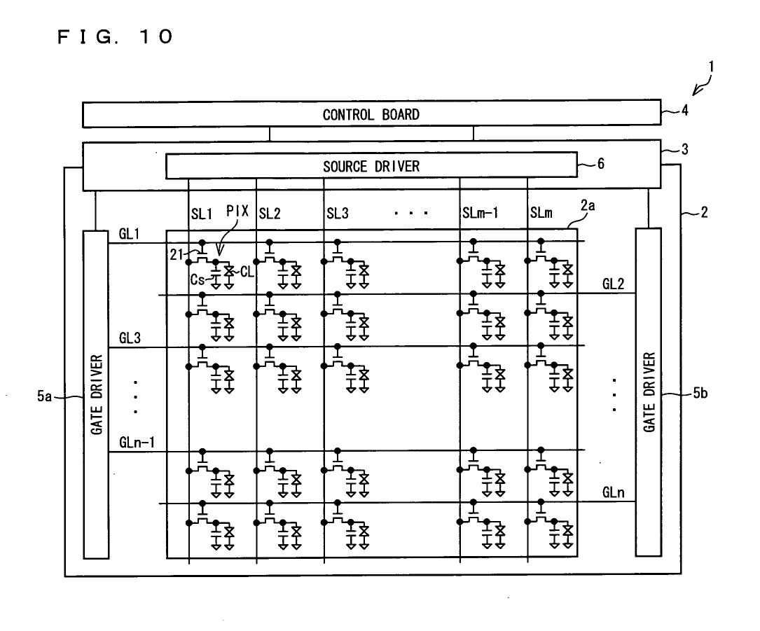

FIG. 10 shows the configuration of a liquid crystal display device 1 that is a first display device according to the present embodiment.

The liquid crystal display device 1 includes a display panel 2, a flexible printed circuit board 3, and a control board 4.

The display panel 2 is an active matrix display panel arranged such that, using amorphous silicon, polycrystalline silicon, CG silicon, microcrystalline silicon, or the like silicon, a display region 2a, a plurality of gate lines (scan signal lines) GL, a plurality of source lines (data signal lines) SL, and gate drivers (scan signal line driving circuits) 5a and 5b are built onto a glass substrate. The display region 2a is a region where a plurality of pixels PIX are arranged in a matrix manner. Each of the pixels PIX includes a TFT 21 that is a selection element of a pixel, a liquid crystal capacitor CL, and an auxiliary capacitor Cs. A gate of the TFT 21 is connected to the gate line GL, and a source of the TFT 21 is connected to the source line SL. The liquid crystal capacitor CL and auxiliary capacitor Cs are connected to a drain of the TFT 21.

The plurality of gate lines GL are gate lines GL1, GL2, GL3, . . . and GLn. Among these, the gate lines GL in a first group consisting of the alternate gate lines GL1, GL3, GL5, are connected to respective outputs of the gate driver (first scan signal line driving circuit) 5a, and the gate lines GL in a second group consisting of the other alternate gate lines GL2, GL4, GL6, . . . are connected to respective outputs of the gate driver (second scan signal line driving circuit) 5b. The plurality of source lines SL are source lines SL1, SL2, SL3, . . . , SLm, which are connected to respective outputs of a source driver 6 that will be described later. Although not shown, an auxiliary capacitor line is formed to apply an auxiliary capacitor voltage to each of the auxiliary capacitors Cs of the pixels PIX.

The gate driver 5a is provided in one of two regions adjoining the display region 2a of the display panel 2 in a direction in which the gate lines GL extend, and sequentially supplies a gate pulse (scan pulse) to each of the gate lines GL1, GL3, GL5, . . . of the first group. The gate driver 5b is provided in the other region adjoining the display region 2a of the display panel 2, and sequentially supplies a gate pulse (scan pulse) to each of the gate lines GL2, GL4, GL6, of the second group. These gate drivers 5a and 5b are formed from amorphous silicon, polycrystalline silicon, CG silicon, microcrystalline silicon, or the like silicon and built into the display panel 2 so as to be monolithically fabricated with the display region 2a. Examples of the gate drivers 5a and 5b can include all gate drivers referred to with the terms such as “monolithic gate driver”, “gate driver-free”, “built-in gate driver in panel”, and “gate in panel”.

The flexible printed circuit board 3 includes the source driver 6. The source driver 6 supplies a data signal to each of the source lines SL. The control board 4 is connected to the flexible printed circuit board 3 and supplies necessary signals and power to the gate drivers 5a and 5b and the source driver 6. The signals and power to be supplied to the gate drivers 5a and 5b from the control board 4 pass through the flexible printed circuit board 3 and are then supplied to the gate driver 15 on the display panel 2.

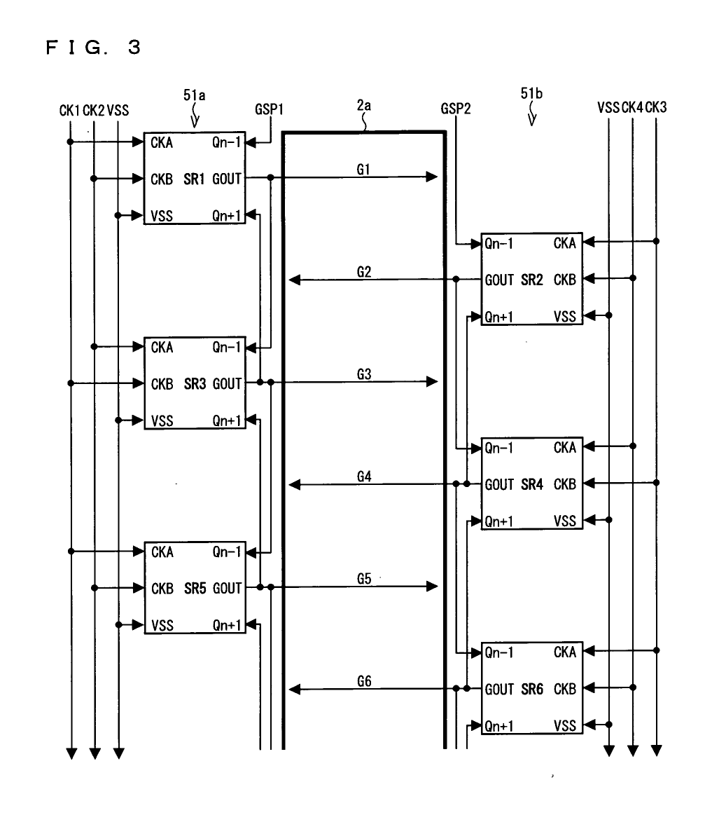

FIG. 3 shows the configurations of the respective gate drivers 5a and 5b.

The gate driver 5a includes a first shift register 51a having a plurality of cascaded shift register stages SR (SR1, SR3, SR5, . . . ) therein. Each of the shift register stages SR includes a set input terminal Qn−1, an output terminal GOUT, a reset input terminal Qn+1, clock input terminals CKA and CKB, and a Low power source input terminal VSS. From the control board 4 are supplied a clock signal (first clock signal) CK1, a clock signal (second clock signal) CK2, a gate start pulse (shift pulse) GSP1, and Low power source VSS (For convenience of explanation, the same reference sign as that for the Low power source input terminal VSS is used). The Low power source VSS may be at negative potential, at ground potential, or at positive potential. However, the Low power source VSS is herein assumed at negative potential to ensure OFF state of the TFTs.

In the first shift register 51a, an output from the output terminal GOUT of a j-numbered (j=1, 2, 3, . . . , i=1, 3, 5, . . . , j=(i+1)/2) shift register stage SRi is a gate output Gi to be outputted to an i-th gate line GLi.

To the set input terminal Qn−1 of a first shift register stage SR1 that lies at one of opposite ends in the scanning direction, the gate start pulse GSP1 is supplied. To the respective set input terminals Qn−1 of the j-numbered second and succeeding shift register stages SRi, gate outputs Gi−2 of preceding shift register stages SRi−2 are supplied. Further, to the respective reset input terminals Qn+1 thereof, gate outputs Gi+2 of subsequent shift register stages SRi+2 are supplied.

In the alternate j-numbered shift register stages (first stages) SR that start from the first shift register stage SRi, the clock signal CK1 is supplied to the clock input terminals CKA, and the clock signal CK2 is supplied to the clock input terminals CKB. In the alternate j-numbered shift register stages (second stages) SR that start from the second shift register stage SR3, the clock signal CK2 is supplied to the clock input terminals CKA, and the clock signal CK1 is supplied to the clock input terminals CKB. In this manner, the first and second stages are aligned alternately in the first shift register 51a.

The clock signals CK1 and CK2 have waveforms as shown in (b) of FIG. 1 (see CKA and CKB for CK1 and CK2, respectively). The clock signals CK1 and CK2 are arranged so that their clock pulses do not overlap each other. In addition, timings for the clock signals CK1 and CK2 are such that the clock pulse of the clock signal CK1 appears after a one clock pulse delay subsequent to the clock pulse of the clock signal CK2, and the clock pulse of the clock signal CK2 appears after a one clock pulse delay subsequent to the clock pulse of the clock signal CK1.

The gate driver 5b includes a second shift register 51b having a plurality of cascaded shift register stages SR (SR2, SR4, SR6, . . . ) therein. Each of the shift register stages SR includes a set input terminal Qn−1, an output terminal GOUT, a reset input terminal Qn+1, clock input terminals CKA and CKB, and a Low power source input terminal VSS. From the control board 4 are supplied a clock signal (third clock signal) CK3, a clock signal (fourth clock signal) CK4, a gate start pulse (shift pulse) GSP2, and the Low power source VSS.

In the second shift register 51b, an output from the output terminal GOUT of a k-numbered (k=1, 2, 3, . . . , i=2, 4, 6, . . . , k=i/2) shift register stage SRi is a gate output Gi to be outputted to an i-th gate line GLi.

To the set input terminal Qn−1 of a first shift register stage SR2 that lies at one of opposite ends in the scanning direction, the gate start pulse GSP2 is supplied. To the respective set input terminals Qn−1 of the k-numbered second and succeeding shift register stages SRi, gate outputs Gi−2 of preceding shift register stages SRi−2 are supplied. Further, to the respective reset input terminals Qn+1 thereof, gate outputs Gi+2 of subsequent shift register stages SRi+2 are supplied.

In the alternate k-numbered shift register stages (third stages) SR that start from the first shift register stage SR2, the clock signal CK3 is supplied to the clock input terminals CKA, and the clock signal CK4 is supplied to the clock input terminals CKB. In the alternate k-numbered shift register stages (fourth stages) SR that start from the second shift register stage SR4, the clock signal CK4 is supplied to the clock input terminals CKA, and the clock signal CK3 is supplied to the clock input terminals CKB. In this manner, the third and fourth stages are aligned alternately in the second shift register 51b.

The clock signals CK3 and CK4 have waveforms as shown in (b) of FIG. 1 (see CKA and CKB for CK3 and CK4, respectively). The clock signals CK3 and CK4 are arranged so that their clock pulses do not overlap each other. In addition, timings for the clock signals CK3 and CK4 are such that the clock pulse of the clock signal CK3 appears after a one clock pulse delay subsequent to the clock pulse of the clock signal CK4, and the clock pulse of the clock signal CK4 appears after a one clock pulse delay subsequent to the clock pulse of the clock signal CK3.

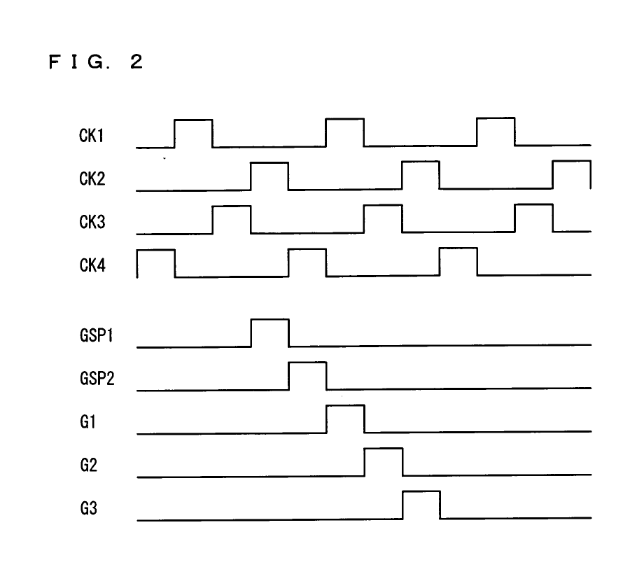

Further, as shown in FIG. 2, timings for the clock signals CK1, CK2, CK3, and CK4 are such that the clock pulse of the clock signal CK1 appears subsequently to the clock pulse of the clock signal CK4, the clock pulse of the clock signal CK3 appears subsequently to the clock pulse of the clock signal CK1, the clock pulse of the clock signal CK2 appears subsequently to the clock pulse of the clock signal CK3, and the clock pulse of the clock signal CK4 appears subsequently to the clock pulse of the clock signal CK2.

As shown in FIG. 2, the gate start pulses GSP1 and GSP2 are pulses such that the gate start pulse GSP1 precedes the gate start pulse GSP2 and the gate start pulses GSP1 and GSP2 are adjacent to each other. The pulse of the gate start pulse GSP1 is in synchronism with the clock pulse of the clock signal CK2, and the pulse of the gate start pulse GSP2 is in synchronism with the clock pulse of the clock signal CK4.

Next, the following will describe the configuration of the shift register stage SRi of the shift registers 51a and 51b with reference to (a) of FIG. 1.

The shift register stage SRi includes transistors Tr1, Tr2, Tr3, and Tr4 and a capacitor CAP. These transistors are all n-channel type TFTs.

As to the transistor Tr1, a gate and a drain are connected to a set input terminal Qn−1, and a source is connected to a gate of the transistor Tr4. As to the transistor Tr4, a drain is connected to a clock input terminal CKA, and a source is connected to an output terminal GOUT. That is, the transistor Tr4 serves as a transfer gate to perform passage and interruption of a clock signal to be supplied to the clock input terminal CKA. The capacitor CAP is provided between the gate and the source of the transistor Tr4. A node that is set to the same potential as the gate of the transistor Tr4 is referred to as a netA.

As to the transistor Tr2 (corresponding to the first transistor in the first shift register 51a and the second transistor in the second shift register 51b), a gate is connected to the clock input terminal CKB, a drain is connected to the output terminal GOUT, and a source is connected to the Low power source input terminal VSS. As to the transistor Tr3, a gate is connected to the reset input terminal Qn+1, a drain is connected to the output terminal GOUT, and a source is connected to the Low power source input terminal VSS.

Next, with reference to (b) of FIG. 1, the following will describe the operations of the shift register stage SRi configured as shown in (a) of FIG. 1.

When a shift pulse is supplied to the set input terminal Qn−1, the transistor Tr1 is turned ON, which charges the capacitor CAP. For the shift register stages SR1 and SR2, the shift pulse corresponds to the gate start pulses GSP1 and GSP2, respectively. For the other shift register stages SRi, the shift pulse corresponds to gate outputs Gj−1 and Gk−1 from preceding shift register stages. Charging of the capacitor CAP increases a potential of the node netA and causes the transistor Tr4 to be turned ON. This causes the clock signal supplied through the clock input terminal CKA to appear in the source of the transistor Tr4. At the instant when the subsequent clock pulse is supplied to the clock input terminal CKA, the potential of the node netA rapidly increases due to the bootstrap effect of the capacitor CAP, and the incoming clock pulse is transferred to the output terminal GOUT of the shift register stage SRi and outputted from the output terminal GOUT as a gate pulse.

When the supply of the gate pulse to the set input terminal Qn−1 is completed, the transistor Tr4 is turned OFF. Then, in order to release charge retention caused by floating of the node netA and the output terminal GOUT of the shift register stage SRi, the transistor Tr3 is turned ON by a reset pulse supplied to the reset input terminal Qn+1. This causes the node netA and the output terminal GOUT to be set to a potential of the Low power source VSS.

Thereafter, until the shift pulse is supplied to the set input terminal Qn−1 again, the transistor Tr2 is periodically turned ON by the clock pulse supplied to the clock input terminal CKB. This refreshes the node netA and the output terminal GOUT of the shift register stage SRi with Low power source potential, i.e. sinks the gate line GLi voltage down.

In this manner, the gate pulses are sequentially outputted to the gate lines G1, G2, G3, and the like as shown in FIG. 2.

In the present embodiment, the scan signal lines are driven by two different scan signal line driving circuits in an alternate manner. Therefore, when compared with the frequency required under the circumstance where the scan signal lines are all driven by a single scan signal line driving circuit, only a half of the frequency is necessary for each stage of the first and second shift registers to (i) output a scan pulse to a scan signal line by transferring one of the two clock signals and to (ii) to set the scan signal line to a potential of a low-level power source outside the selection period by transferring the other clock signal, i.e. to sink the scan signal line voltage down. Since the timings for the clock pulses of the first through fourth clock signals are defined as described previously, appropriate setting of a gate start pulse for each of the scan signal line driving circuits enables the two different scan signal lines to perform sequential scanning of all of the scan signal lines.

Therefore, it is possible to reduce “ON” duty cycle of a clock pulse to be applied to the gate of the first transistor (transistor Tr2) in each stage of the first shift register and to the gate of the second transistor (transistor Tr2) in each stage of the second shift register, to about half of “ON” duty cycle of a clock pulse in the conventional display device. This makes it possible to curb the occurrence of the phenomenon in which the threshold voltage of the sink-down transistor is shifted.

Thus, it is possible to realize a display device capable of curbing the occurrence of the phenomenon in which the threshold voltage of the sink-down transistor is shifted, while sinking the gate line voltage down.

### Second Embodiment

A second display device according to the present embodiment is different from the liquid crystal display device 1 shown in FIG. 10 in that the shift registers of the gate drivers 5a and 5b are differently configured.

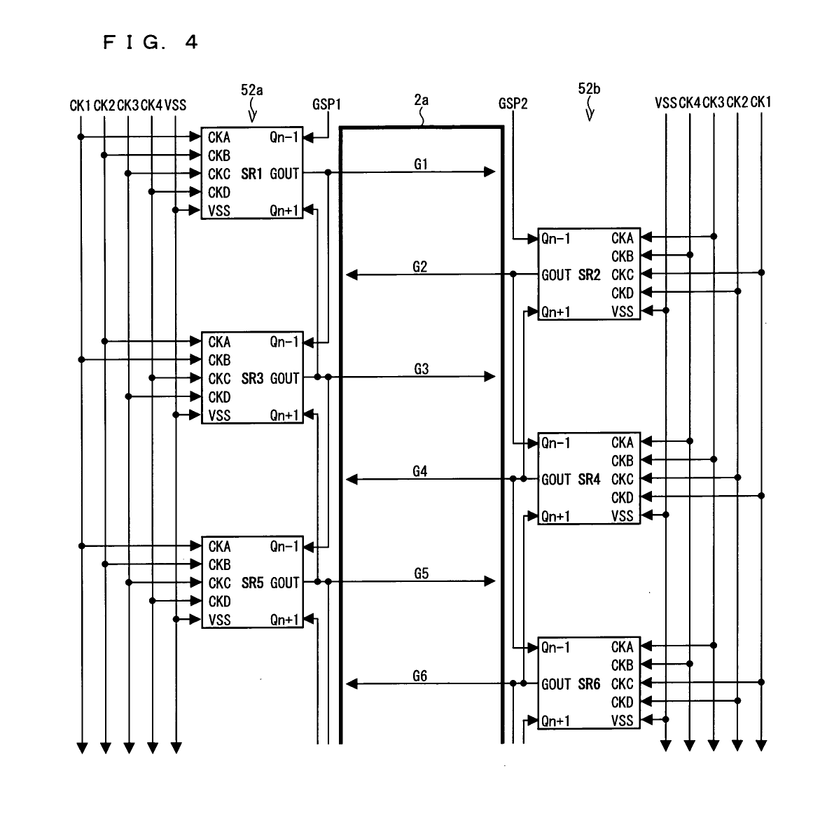

The respective configurations of the gate drivers 5a and 5b in such a case are shown in FIG. 4.

The gate driver 5a includes a first shift register 52a having a plurality of cascaded shift register stages SR (SR1, SR3, SR5, . . . ) therein. Each of the shift register stages SR includes a set input terminal Qn−1, an output terminal GOUT, a reset input terminal Qn+1, clock input terminals CKA, CKB, CKC, CKD, and a Low power source input terminal VSS. From the control board 4 are supplied a clock signal (first clock signal) CK1, a clock signal (second clock signal) CK2, a clock signal (third clock signal) CK3, a clock signal (fourth clock signal) CK4, a gate start pulse (shift pulse) GSP1, and Low power source VSS (For convenience of explanation, the same reference sign as that for the Low power source input terminal VSS is used). The Low power source VSS may be at negative potential, at ground potential, or at positive potential. However, the Low power source VSS is herein assumed at negative potential to ensure OFF state of the TFTs.

In the first shift register 52a, an output from the output terminal GOUT of a j-numbered (j=1, 2, 3, . . . , i=1, 3, 5, . . . , j=(i+1)/2) shift register stage SRi is a gate output Gi to be outputted to an i-th gate line GLi.

To the set input terminal Qn−1 of a first shift register stage SR1 that lies at one of opposite ends in the scanning direction, the gate start pulse GSP1 is supplied. To the respective set input terminals Qn−1 of the j-numbered second and succeeding shift register stages SRi, gate outputs Gi−2 of preceding shift register stages SRi−2 are supplied. Further, to the respective reset input terminals Qn+1 thereof, gate outputs Gi+2 of subsequent shift register stages SRi+2 are supplied.

In the alternate j-numbered shift register stages (first stages) SR that start from the first shift register stage SR1, the clock signal CK1 is supplied to the clock input terminals CKA, the clock signal CK2 is supplied to the clock input terminals CKB, the clock signal CK3 is supplied to the clock input terminals CKC, and the clock signal CK4 is supplied to the clock input terminals CKD. In the alternate j-numbered shift register stages (second stages) SR that start from the second shift register stage SR3, the clock signal CK2 is supplied to the clock input terminals CKA, the clock signal CK1 is supplied to the clock input terminals CKB, the clock signal CK4 is supplied to the clock input terminals CKC, and the clock signal CK3 is supplied to the clock input terminals CKD. In this manner, the first and second stages are aligned alternately in the first shift register 52a.

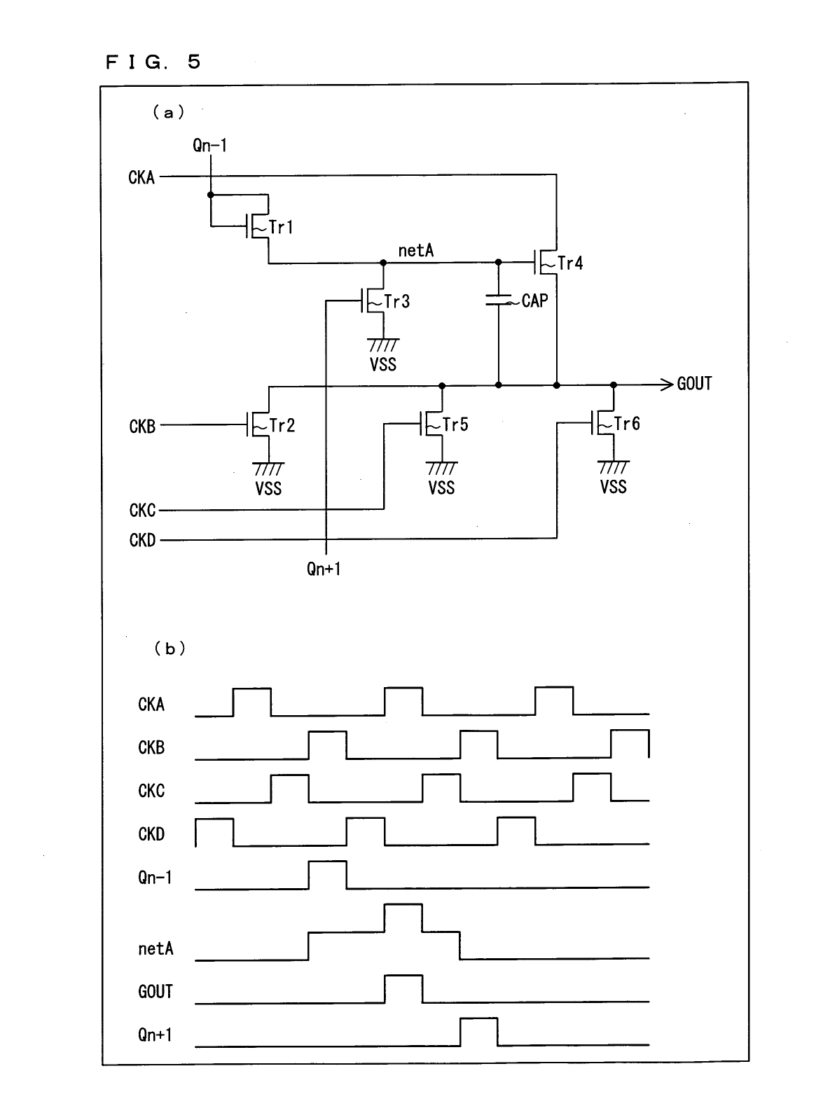

The clock signals CK1, CK2, CK3, CK4 have waveforms as shown in (b) of FIG. 5 (see CKA, CKB, CKC, and CKD for CK1, CK2, CK3, and CK4, respectively).

The clock signals CK1 and CK2 are arranged so that their clock pulses do not overlap each other. In addition, timings for the clock signals CK1 and CK2 are such that the clock pulse of the clock signal CK1 appears after a one clock pulse delay subsequent to the clock pulse of the clock signal CK2, and the clock pulse of the clock signal CK2 appears after a one clock pulse delay subsequent to the clock pulse of the clock signal CK1.

The clock signals CK3 and CK4 are arranged so that their clock pulses do not overlap each other. In addition, timings for the clock signals CK3 and CK4 are such that the clock pulse of the clock signal CK3 appears after a one clock pulse delay subsequent to the clock pulse of the clock signal CK4, and the clock pulse of the clock signal CK4 appears after a one clock pulse delay subsequent to the clock pulse of the clock signal CK3.

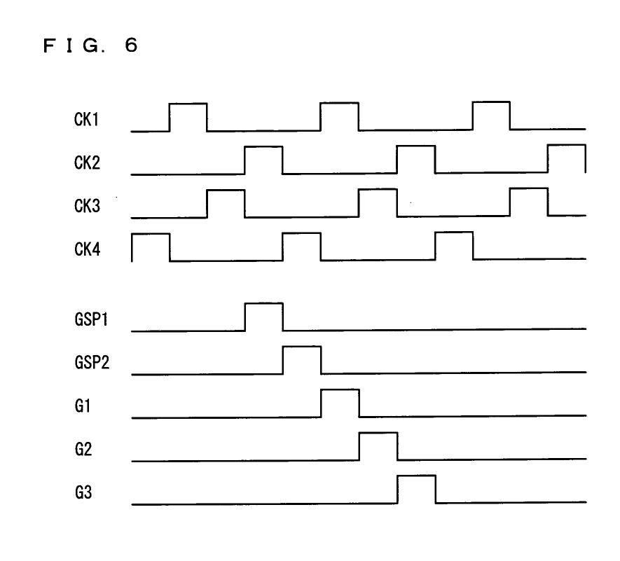

Further, as shown in (b) of FIG. 5 and FIG. 6, timings for the clock signals CK1, CK2, CK3, and CK4 are such that the clock pulse of the clock signal CK1 appears subsequently to the clock pulse of the clock signal CK4, the clock pulse of the clock signal CK3 appears subsequently to the clock pulse of the clock signal CK1, the clock pulse of the clock signal CK2 appears subsequently to the clock pulse of the clock signal CK3, and the clock pulse of the clock signal CK4 appears subsequently to the clock pulse of the clock signal CK2.

As shown in FIG. 6, the gate start pulses GSP1 and GSP2 are pulses such that the gate start pulse GSP1 precedes the gate start pulse GSP2 and the gate start pulses GSP1 and GSP2 are adjacent to each other. The pulse of the gate start pulse GSP1 is in synchronism with the clock pulse of the clock signal CK2, and the pulse of the gate start pulse GSP2 is in synchronism with the clock pulse of the clock signal CK4.

The gate driver 5b includes a second shift register 52b having a plurality of cascaded shift register stages SR (SR2, SR4, SR6, . . . ) therein. Each of the shift register stages SR includes a set input terminal Qn−1, an output terminal GOUT, a reset input terminal Qn+1, clock input terminals CKA, CKB, CKC, CKD, and a Low power source input terminal VSS. From the control board 4 are supplied a clock signal (first clock signal) CK1, a clock signal (second clock signal) CK2, a clock signal (third clock signal) CK3, a clock signal (fourth clock signal) CK4, a gate start pulse (shift pulse) GSP2, and the Low power source VSS.

In the second shift register 52b, an output from the output terminal GOUT of a k-numbered (k=1, 2, 3, . . . , i=2, 4, 6, . . . , k=i/2) shift register stage SRi is a gate output Gi to be outputted to an i-th gate line GLi.

To the set input terminal Qn−1 of a first shift register stage SR2 that lies at one of opposite ends in the scanning direction, the gate start pulse GSP2 is supplied. To the respective set input terminals Qn−1 of the k-numbered second and succeeding shift register stages SRi, gate outputs Gi−2 of preceding shift register stages SRi-2 are supplied. Further, to the respective reset input terminals Qn+1 thereof, gate outputs Gi+2 of subsequent shift register stages SRi+2 are supplied.

In the alternate k-numbered shift register stages (third stages) SR that start from the first shift register stage SR2, the clock signal CK3 is supplied to the clock input terminals CKA, the clock signal CK4 is supplied to the clock input terminals CKB, the clock signal CK1 is supplied to the clock input terminals CKC, and the clock signal CK2 is supplied to the clock input terminals CKD. In the alternate k-numbered shift register stages (fourth stages) SR that start from the second shift register stage SR4, the clock signal CK4 is supplied to the clock input terminals CKA, the clock signal CK3 is supplied to the clock input terminals CKB, the clock signal CK2 is supplied to the clock input terminals CKC, and the clock signal CK1 is supplied to the clock input terminals CKD. In this manner, the third and fourth stages are aligned alternately in the second shift register 52b.

Next, the following will describe the configuration of the shift register stage SRi of the first and second shift registers 52a and 52b with reference to (a) of FIG. 5.

The shift register stage SRi includes transistors Tr1, Tr2, Tr3, Tr4, Tr5, and Tr6 and a capacitor CAP. These transistors are all n-channel type TFTs.

As to the transistor Tr1, a gate and a drain are connected to a set input terminal Qn−1, and a source is connected to a gate of the transistor Tr4. As to the transistor Tr4, a drain is connected to a clock input terminal CKA, and a source is connected to an output terminal GOUT. That is, the transistor Tr4 serves as a transfer gate to perform passage and interruption of a clock signal to be supplied to the clock input terminal CKA. The capacitor CAP is provided between the gate and the source of the transistor Tr4. A node that is set to the same potential as the gate of the transistor Tr4 is referred to as a netA.

As to the transistor Tr2 (corresponding to the first transistor in the first shift register 52a and the fourth transistor in the second shift register 52b), a gate is connected to the clock input terminal CKB, a drain is connected to the output terminal GOUT, and a source is connected to the Low power source input terminal VSS. As to the transistor Tr3, a gate is connected to the reset input terminal Qn+1, a drain is connected to the output terminal GOUT, and a source is connected to the Low power source input terminal VSS.

As to the transistor Tr5 (corresponding to the second transistor in the first shift register 52a and the fifth transistor in the second shift register 52b), a gate is connected to the clock input terminal CKC, a drain is connected to the output terminal GOUT, and a source is connected to the Low power source input terminal VSS. As to the transistor Tr6 (corresponding to the third transistor in the first shift register 52a and the sixth transistor in the second shift register 52b), a gate is connected to the clock input terminal CKD, a drain is connected to the output terminal GOUT, and a source is connected to the Low power source input terminal VSS.

Next, with reference to (b) of FIG. 5, the following will describe the operations of the shift register stage SRi configured as shown in (a) of FIG. 5.

When a shift pulse is supplied to the set input terminal Qn−1, the transistor Tr1 is turned ON, which charges the capacitor CAP. For the shift register stages SR1 and SR2, the shift pulse corresponds to the gate start pulses GSP1 and GSP2, respectively. For the other shift register stages SRi, the shift pulse corresponds to gate outputs Gj−1 and Gk−1 from preceding shift register stages. Charging of the capacitor CAP increases a potential of the node netA and causes the transistor Tr4 to be turned ON. This causes the clock signal supplied through the clock input terminal CKA to appear in the source of the transistor Tr4. At the instant when the subsequent clock pulse is supplied to the clock input terminal CKA, the potential of the node netA rapidly increases due to the bootstrap effect of the capacitor CAP, and the incoming clock pulse is transferred to the output terminal GOUT of the shift register stage SRi and outputted from the output terminal GOUT as a gate pulse.

When the supply of the gate pulse to the set input terminal Qn−1 is completed, the transistor Tr4 is turned OFF. Then, in order to release charge retention caused by floating of the node netA and the output terminal GOUT of the shift register stage SRi, the transistor Tr3 is turned ON by a reset pulse supplied to the reset input terminal Qn+1. This causes the node netA and the output terminal GOUT to be set to a potential of the Low power source VSS.

Thereafter, until the shift pulse is supplied to the set input terminal Qn−1 again, the transistors Tr2, Tr5, Tr6 are periodically turned ON by the clock pulse supplied to the clock input terminal CKB. This refreshes the node netA and the output terminal GOUT of the shift register stage SRi with Low power source potential, i.e. sinks the gate line GLi voltage down.

In this manner, the gate pulses are sequentially outputted to the gate lines G1, G2, G3, and the like as shown in FIG. 6.

In the present embodiment, the scan signal lines are driven by two different scan signal line driving circuits in an alternate manner. Therefore, when compared with the frequency required under the circumstance where the scan signal lines are all driven by a single scan signal line driving circuit, only a half of the frequency is necessary for each stage of the first and second shift registers to (i) output a scan pulse to a scan signal line by transferring one clock signal and to (ii) to set the scan signal line to a potential of a low-level power source outside the selection period by transferring the other three clock signals, i.e. to sink the scan signal line voltage down. Since the timings for the clock pulses of the first through fourth clock signals are defined as described previously, appropriate setting of a gate start pulse for each of the scan signal line driving circuits enables the two different scan signal lines to perform sequential scanning of all of the scan signal lines.

Therefore, it is possible to reduce “ON” duty cycle of a clock pulse to be applied to the respective gates of the first through third transistors in each stage of the first shift register and to the respective gates of the fourth through sixth transistors in each stage of the second shift register, to about half of “ON” duty cycle of a clock pulse in the conventional display device. This makes it possible to curb the occurrence of the phenomenon in which the threshold voltage of the sink-down transistor is shifted. Further, three sink-down transistors (transistors Tr2, Tr5, and Tr6) are provided in each of the stages, and “sinking” is performed during a period in which the clock pulse is supplied to each of the three sink-down transistors. This makes it possible to realize sinking the scan signal line voltage down for a long time, and to realize further stabilization of a potential of the scan signal line outside the selection period of the scan signal line.

Thus, it is possible to realize a display device capable of curbing the occurrence of the phenomenon in which the threshold voltage of the sink-down transistor is shifted, while sinking the gate line voltage down.

### Third Embodiment

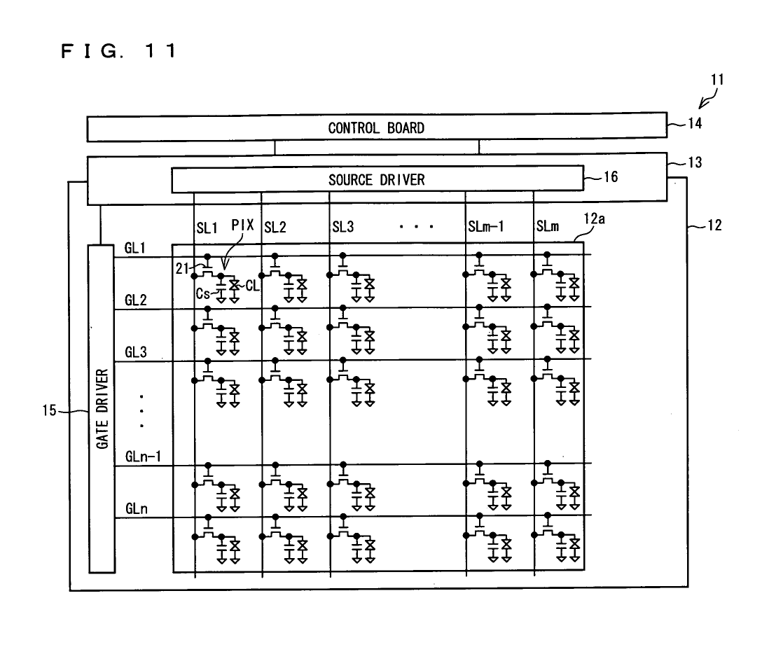

FIG. 11 shows the configuration of a liquid crystal display device 11 that is a third display device according to the present embodiment.

The liquid crystal display device 11 includes a display panel 12, a flexible printed circuit board 13, and a control board 14.

The display panel 12 is an active matrix display panel arranged such that, using amorphous silicon, polycrystalline silicon, CG silicon, microcrystalline silicon, or the like silicon, a display region 12a, a plurality of gate lines (scan signal lines) GL, a plurality of source lines (data signal lines) SL, and gate drivers (scan signal line driving circuits) 15 are built onto a glass substrate. The display region 12a is a region where a plurality of pixels PIX are arranged in a matrix manner. Each of the pixels PIX includes a TFT 21 that is a selection element of a pixel, a liquid crystal capacitor CL, and an auxiliary capacitor Cs. A gate of the TFT 21 is connected to the gate line GL, and a source of the TFT 21 is connected to the source line SL. The liquid crystal capacitor CL and auxiliary capacitor Cs are connected to a drain of the TFT 21.

The plurality of gate lines GL are gate lines GL1, GL2, GL3, . . . and GLn, which are connected to respective outputs of the gate driver (scan signal line driving circuit) 15. The plurality of source lines SL are source lines SL1, SL2, SL3, . . . SLm, which are connected to respective outputs of a source driver 16 that will be described later. Although not shown, an auxiliary capacitor line is formed to apply an auxiliary capacitor voltage to each of the auxiliary capacitors Cs of the pixels PIX.

The gate driver 15 is provided in one of two regions adjoining the display region 12a of the display panel 12 in a direction in which the gate lines GL extend, and sequentially supplies a gate pulse (scan pulse) to each of the gate lines GL. The gate driver 15 is formed from amorphous silicon, polycrystalline silicon, CG silicon, microcrystalline silicon, or the like silicon and built into the display panel 12 so as to be monolithically fabricated with the display region 12. Examples of the gate driver 15 can include all gate drivers referred to with the terms such as “monolithic gate driver”, “gate driver-free”, “built-in gate driver in panel”, and “gate in panel”.

The flexible printed circuit board 13 includes the source driver 16. The source driver 16 supplies a data signal to each of the source lines SL. The control board 14 is connected to the flexible printed circuit board 3 and supplies necessary signals and power to the gate driver 15 and the source driver 16. The signals and power to be supplied to the gate driver 15 from the control board 14 pass through the flexible printed circuit board 13 and are then supplied to the gate driver 15 on the display panel 12.

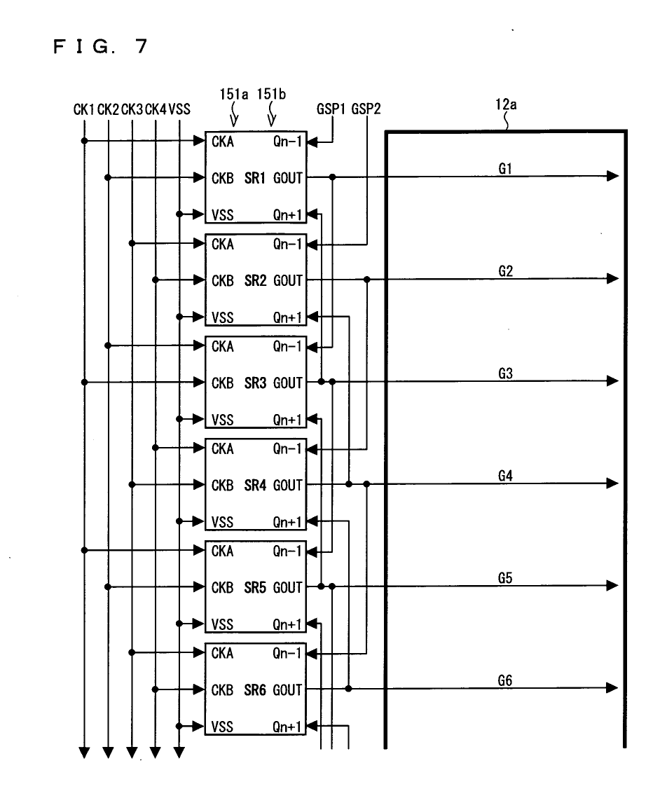

FIG. 7 shows the configuration of the gate driver 15.

The gate driver 15 includes a first shift register 151a having a plurality of cascaded shift register stages SR (SR1, SR3, SR5, . . . ) and a second shift register 151b having a plurality of cascaded shift register stages SR (SR2, SR4, SR6, . . . ).

In the first shift register 151a, each of the shift register stages SR includes a set input terminal Qn−1, an output terminal GOUT, a reset input terminal Qn+1, clock input terminals CKA and CKB, and a Low power source input terminal VSS. From the control board 14 are supplied a clock signal (first clock signal) CK1, a clock signal (second clock signal) CK2, a gate start pulse (shift pulse) GSP1, and Low power source VSS (For convenience of explanation, the same reference sign as that for the Low power source input terminal VSS is used). The Low power source VSS may be at negative potential, at ground potential, or at positive potential. However, the Low power source VSS is herein assumed at negative potential to ensure OFF state of the TFTs.

In the first shift register 151a, an output from the output terminal GOUT of a j-numbered (j=1, 2, 3, . . . , i=1, 3, 5, . . . , k(i+1)/2) shift register stage SRi is a gate output Gi to be outputted to an i-th gate line GLi.

To the set input terminal Qn−1 of a first shift register stage SR1 that lies at one of opposite ends in the scanning direction, the gate start pulse GSP1 is supplied. To the respective set input terminals Qn−1 of the j-numbered second and succeeding shift register stages SRi, gate outputs Gi−2 of preceding shift register stages SRi−2 are supplied. Further, to the respective reset input terminals Qn+1 thereof, gate outputs Gi+2 of subsequent shift register stages SRi+2 are supplied.

In the alternate j-numbered shift register stages (first stages) SR that start from the first shift register stage SR1, the clock signal CK1 is supplied to the clock input terminals CKA, and the clock signal CK2 is supplied to the clock input terminals CKB. In the alternate j-numbered shift register stages (second stages) SR that start from the second shift register stage SR3, the clock signal CK2 is supplied to the clock input terminals CKA, and the clock signal CK1 is supplied to the clock input terminals CKB. In this manner, the first and second stages are aligned alternately in the first shift register 151a.

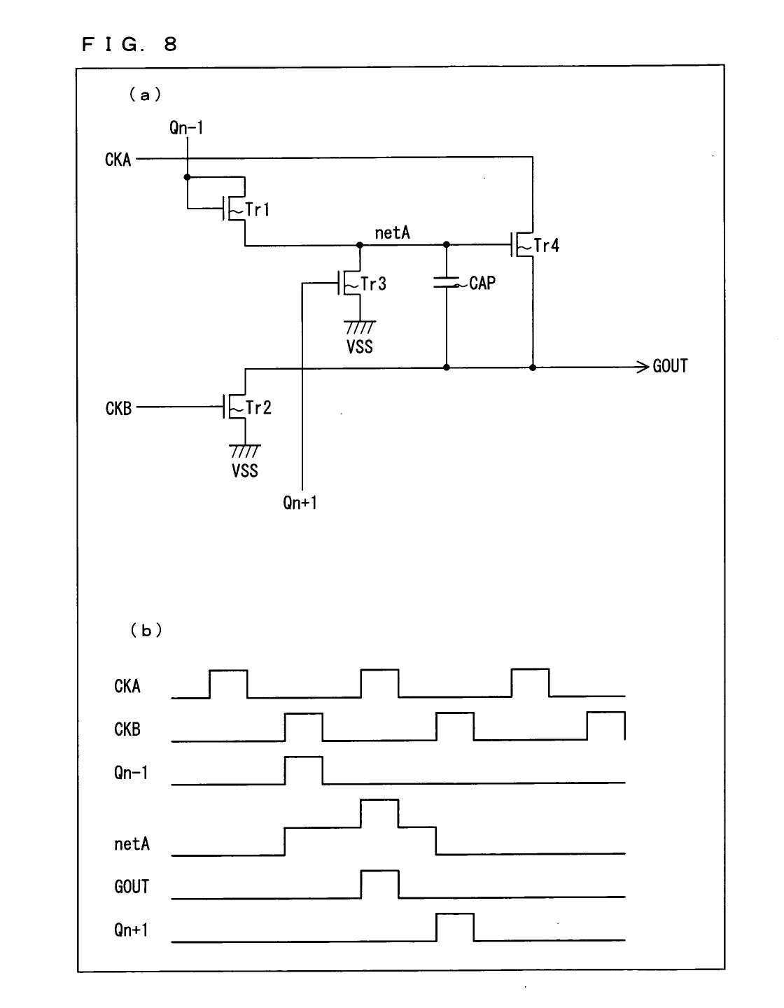

The clock signals CK1 and CK2 have waveforms as shown in (b) of FIG. 8 (see CKA and CKB for CK1 and CK2, respectively). The clock signals CK1 and CK2 are arranged so that their clock pulses do not overlap each other. In addition, timings for the clock signals CK1 and CK2 are such that the clock pulse of the clock signal CK1 appears after a one clock pulse delay subsequent to the clock pulse of the clock signal CK2, and the clock pulse of the clock signal CK2 appears after a one clock pulse delay subsequent to the clock pulse of the clock signal CK1.

In the second shift register 151b, each of the shift register stages SR includes a set input terminal Qn−1, an output terminal GOUT, a reset input terminal Qn+1, clock input terminals CKA and CKB, and a Low power source input terminal VSS. From the control board 14 are supplied a clock signal (third clock signal) CK3, a clock signal (fourth clock signal) CK4, a gate start pulse (shift pulse) GSP2, and the Low power source VSS.

In the second shift register 151b, an output from the output terminal GOUT of a k-numbered (k=1, 2, 3, . . . , i=2, 4, 6, . . . , k=i/2) shift register stage SRi is a gate output Gi to be outputted to an i-th gate line GLi.

To the set input terminal Qn−1 of a first shift register stage SR2 that lies at one of opposite ends in the scanning direction, the gate start pulse GSP2 is supplied. To the respective set input terminals Qn−1 of the k-numbered second and succeeding shift register stages SRi, gate outputs Gi−2 of preceding shift register stages SRi−2 are supplied. Further, to the respective reset input terminals Qn+1 thereof, gate outputs Gi+2 of subsequent shift register stages SRi+2 are supplied.

In the alternate k-numbered shift register stages (third stages) SR that start from the first shift register stage SR2, the clock signal CK3 is supplied to the clock input terminals CKA, and the clock signal CK4 is supplied to the clock input terminals CKB. In the alternate k-numbered shift register stages (fourth stages) SR that start from the second shift register stage SR4, the clock signal CK4 is supplied to the clock input terminals CKA, and the clock signal CK3 is supplied to the clock input terminals CKB. In this manner, the third and fourth stages are aligned alternately in the second shift register 151b.

The clock signals CK3 and CK4 have waveforms as shown in (b) of FIG. 8 (see CKA and CKB for CK3 and CK4, respectively). The clock signals CK3 and CK4 are arranged so that their clock pulses do not overlap each other. In addition, timings for the clock signals CK3 and CK4 are such that the clock pulse of the clock signal CK3 appears after a one clock pulse delay subsequent to the clock pulse of the clock signal CK4, and the clock pulse of the clock signal CK4 appears after a one clock pulse delay subsequent to the clock pulse of the clock signal CK3.

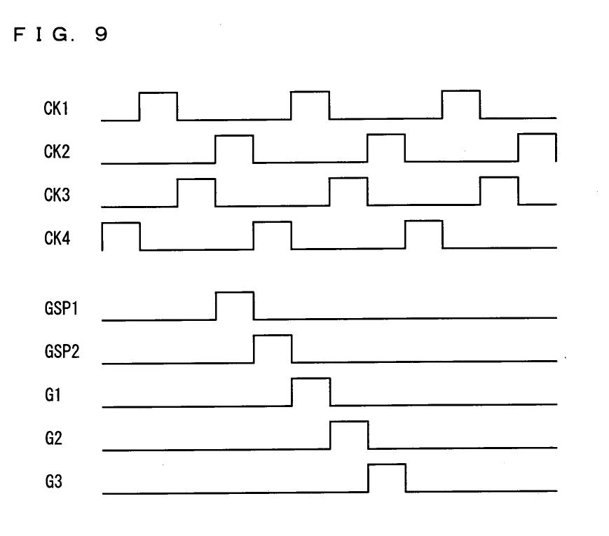

Further, as shown in FIG. 9, timings for the clock signals CK1, CK2, CK3, and CK4 are such that the clock pulse of the clock signal CK1 appears subsequently to the clock pulse of the clock signal CK4, the clock pulse of the clock signal CK3 appears subsequently to the clock pulse of the clock signal CK1, the clock pulse of the clock signal CK2 appears subsequently to the clock pulse of the clock signal CK3, and the clock pulse of the clock signal CK4 appears subsequently to the clock pulse of the clock signal CK2.

As shown in FIG. 9, the gate start pulses GSP1 and GSP2 are pulses such that the gate start pulse GSP1 precedes the gate start pulse GSP2 and the gate start pulses GSP1 and GSP2 are adjacent to each other. The pulse of the gate start pulse GSP1 is in synchronism with the clock pulse of the clock signal CK2, and the pulse of the gate start pulse GSP2 is in synchronism with the clock pulse of the clock signal CK4.

Next, the following will describe the configuration of the shift register stage SRi of the first and second shift registers 151a and 151b with reference to (a) of FIG. 8.

The shift register stage SRi includes transistors Tr1, Tr2, Tr3, and Tr4 and a capacitor CAP. These transistors are all n-channel type TFTs.

As to the transistor Tr1, a gate and a drain are connected to a set input terminal Qn−1, and a source is connected to a gate of the transistor Tr4. As to the transistor Tr4, a drain is connected to a clock input terminal CKA, and a source is connected to an output terminal GOUT. That is, the transistor Tr4 serves as a transfer gate to perform passage and interruption of a clock signal to be supplied to the clock input terminal CKA. The capacitor CAP is provided between the gate and the source of the transistor Tr4. A node that is set to the same potential as the gate of the transistor Tr4 is referred to as a netA.

As to the transistor Tr2 (corresponding to the first transistor in the first shift register 151a and the second transistor in the second shift register 151b), a gate is connected to the clock input terminal CKB, a drain is connected to the output terminal GOUT, and a source is connected to the Low power source input terminal VSS. As to the transistor Tr3, a gate is connected to the reset input terminal Qn+1, a drain is connected to the output terminal GOUT, and a source is connected to the Low power source input terminal VSS.

Next, with reference to (b) of FIG. 8, the following will describe the operations of the shift register stage SRi configured as shown in (a) of FIG. 8.

When a shift pulse is supplied to the set input terminal Qn−1, the transistor Tr1 is turned ON, which charges the capacitor CAP. For the shift register stages SR1 and SR2, the shift pulse corresponds to the gate start pulses GSP1 and GSP2, respectively. For the other shift register stages SRi, the shift pulse corresponds to gate outputs Gj−1 and Gk−1 from preceding shift register stages. Charging of the capacitor CAP increases a potential of the node netA and causes the transistor Tr4 to be turned ON. This causes the clock signal supplied through the clock input terminal CKA to appear in the source of the transistor Tr4. At the instant when the subsequent clock pulse is supplied to the clock input terminal CKA, the potential of the node netA rapidly increases due to the bootstrap effect of the capacitor CAP, and the incoming clock pulse is transferred to the output terminal GOUT of the shift register stage SRi and outputted from the output terminal GOUT as a gate pulse.

When the supply of the gate pulse to the set input terminal Qn−1 is completed, the transistor Tr4 is turned OFF. Then, in order to release charge retention caused by floating of the node netA and the output terminal GOUT of the shift register stage SRi, the transistor Tr3 is turned ON by a reset pulse supplied to the reset input terminal Qn+1. This causes the node netA and the output terminal GOUT to be set to a potential of the Low power source VSS.

Thereafter, until the shift pulse is supplied to the set input terminal Qn−1 again, the transistor Tr2 is periodically turned ON by the clock pulse supplied to the clock input terminal CKB. This refreshes the node netA and the output terminal GOUT of the shift register stage SRi with Low power source potential, i.e. sinks the gate line GLi voltage down.

In this manner, the gate pulses are sequentially outputted to the gate lines G1, G2, G3, and the like as shown in FIG. 9.

In the present embodiment, the scan signal lines are driven by two different shift registers in an alternate manner.

Therefore, when compared with the frequency required under the circumstance where the scan signal lines are all driven by a single scan signal line driving circuit, only a half of the frequency is necessary for each stage of the first and second shift registers to (i) output a scan pulse to a scan signal line by transferring one of the two clock signals and to (ii) to set the scan signal line to a potential of a low-level power source outside the selection period by transferring the other clock signal, i.e. to sink the scan signal line voltage down. Since the timings for the clock pulses of the first through fourth clock signals are defined as described previously, appropriate setting of a gate start pulse for each of the scan signal line driving circuits enables the two different scan signal lines to perform sequential scanning of all of the scan signal lines.

Therefore, it is possible to reduce “ON” duty cycle of a clock pulse to be applied to the gate of the first transistor (transistor Tr2) in each stage of the first shift register and to the gate of the second transistor (transistor Tr2) in each stage of the second shift register, to about half of “ON” duty cycle of a clock pulse in the conventional display device. This makes it possible to curb the occurrence of the phenomenon in which the threshold voltage of the sink-down transistor is shifted.

Thus, it is possible to realize a display device capable of curbing the occurrence of the phenomenon in which the threshold voltage of the sink-down transistor is shifted, while sinking the gate line voltage down.

The above descriptions have discussed the embodiments. Note that the clock signals CK1 through CK4 may be such that timings for clock pulses thereof overlap each other. Further, the clock pulse refers to a period in which the clock signal is active.

The present invention is not limited to the aforementioned embodiments and is susceptible of various changes within the scope of the accompanying claims. That is, an embodiment obtained by suitable combinations of technical means disclosed within the scope of the claims are also included within the technical scope of the present invention.

As described above, a display device of the present invention is a display device comprising: a first scan signal line driving circuit; and a second scan signal line driving circuit, wherein of all scan signal lines consisting of (i) a first group of scan signal lines connected to the first scan signal line driving circuit and (ii) a second group of scan signal lines connected to the second scan signal line driving circuit, the scan signal lines in the first group and the scan signal lines in the second group are disposed in an alternate manner, the first scan signal line driving circuit including a first shift register which receives two clock signals that are first and second clock signals, the first shift register having stages each of which includes first and second clock input terminals, the first shift register being arranged to have first stages and second stages alternately cascaded with each other, each of the first stages being such that the first clock signal is supplied to the first clock input terminal, and the second clock signal is supplied to the second clock input terminal, each of the second stages being such that the second clock signal is supplied to the first clock input terminal, and the first clock signal is supplied to the second clock input terminal, the stages of the first shift register, upon receipt of a shift pulse from a preceding stage, each outputting a scan pulse by transferring a clock pulse of a clock signal supplied through the first clock input terminal to a scan signal line corresponding to the individual stage, the stages of the first shift register each including a first transistor that is provided so as to connect and disconnect a scan signal line corresponding to the individual stage to and from a low-level power source of the scan pulse, the first transistor having a gate receiving a clock signal supplied through the second clock input terminal, the second scan signal line driving circuit including a second shift register which receives two clock signals that are third and fourth clock signals, the second shift register having stages each of which includes third and fourth clock input terminals, the second shift register being arranged to have third stages and fourth stages alternately cascaded with each other, each of the third stages being such that the third clock signal is supplied to the third clock input terminal, and the fourth clock signal is supplied to the fourth clock input terminal, each of the fourth stages being such that the fourth clock signal is supplied to the third clock input terminal, and the third clock signal is supplied to the fourth clock input terminal, the stages of the second shift register, upon receipt of a shift pulse from a preceding stage, each outputting a scan pulse by transferring a clock pulse of a clock signal supplied through the third clock input terminal to a scan signal line corresponding to the individual stage, the stages of the second shift register each including a second transistor that is provided so as to connect and disconnect a scan signal line corresponding to the individual stage to and from a low-level power source of the scan pulse, the second transistor having a gate receiving a clock signal supplied through the fourth clock input terminal, wherein timings for the first clock signal, the second clock signal, the third clock signal, and the fourth clock signal are such that a clock pulse of the first clock signal appears subsequently to a clock pulse of the fourth clock signal, a clock pulse of the third clock signal appears subsequently to a clock pulse of the first clock signal, a clock pulse of the second clock signal appears subsequently to the clock pulse of the third clock signal, and the clock pulse of the fourth clock signal appears subsequently to the clock pulse of the second clock signal.

The above arrangement yields the effect of realizing a display device capable of curbing the occurrence of the phenomenon in which the threshold voltage of the sink-down transistor is shifted, while sinking the gate line voltage down.

As described above, a method for driving a display device according to the present invention is a method for driving a display device comprising: a first scan signal line driving circuit including a first shift register; and a second scan signal line driving circuit including a second shift register, wherein of all scan signal lines consisting of (i) a first group of scan signal lines connected to the first scan signal line driving circuit and (ii) a second group of scan signal lines connected to the second scan signal line driving circuit, the scan signal lines in the first group and the scan signal lines in the second group are disposed in an alternate manner, the method comprising: supplying two clock signals that are first and second clock signals to each of stages of the first shift register; causing the stages of the first shift register to operate so that first stages and second stages are alternately arranged, each of the first stages operating to, upon receipt of a shift pulse from a preceding stage, output a scan pulse by transferring a clock pulse of the first clock signal to a scan signal line corresponding to the individual stage, each of the second stages operating to, upon receipt of a shift pulse from a preceding stage, output a scan pulse by transferring a clock pulse of the second clock signal to a scan signal line corresponding to the individual stage; causing each of the first stages to connect and disconnect a scan signal line corresponding to the individual stage to and from a low-level power source of the scan pulse, when the second clock signal is supplied to a gate of a transistor provided in each of the first stages; causing each of the second stages to connect and disconnect a scan signal line corresponding to the individual stage to and from a low-level power source of the scan pulse, when the first clock signal is supplied to a gate of a transistor provided in each of the second stages; supplying two clock signals that are third and fourth clock signals to each of stages of the second shift register; causing the stages of the second shift register to operate so that third stages and fourth stages are alternately arranged, each of the third stages operating to, upon receipt of a shift pulse from a preceding stage, output a scan pulse by transferring a clock pulse of the third clock signal to a scan signal line corresponding to the individual stage, each of the fourth stages operating to, upon receipt of a shift pulse from a preceding stage, output a scan pulse by transferring a clock pulse of the fourth clock signal to a scan signal line corresponding to the individual stage; causing each of the third stages to connect and disconnect a scan signal line corresponding to the individual stage to and from a low-level power source of the scan pulse, when the fourth clock signal is supplied to a gate of a transistor provided in each of the third stages; and causing each of the fourth stages to connect and disconnect a scan signal line corresponding to the individual stage to and from a low-level power source of the scan pulse, when the third clock signal is supplied to a gate of a transistor provided in each of the fourth stages, wherein timings for the first clock signal, the second clock signal, the third clock signal, and the fourth clock signal are such that the clock pulse of the first clock signal appears subsequently to the clock pulse of the fourth clock signal, the clock pulse of the third clock signal appears subsequently to the clock pulse of the first clock signal, the clock pulse of the second clock signal appears subsequently to the clock pulse of the third clock signal, and the clock pulse of the fourth clock signal appears subsequently to the clock pulse of the second clock signal.

The above arrangement yields the effect of realizing a method for driving a display device capable of curbing the occurrence of the phenomenon in which the threshold voltage of the sink-down transistor is shifted, while sinking the gate line voltage down.

Specific embodiments or examples implemented in the description of the embodiments only show technical features of the present invention and are not intended to limit the scope of the invention. Variations can be effected within the spirit of the present invention and the scope of the following claims.

### INDUSTRIAL APPLICABILITY

The present invention can be suitably used for a liquid crystal display device.

1. A display device comprising an active matrix panel,
the display device further comprising:
a first scan signal line driving circuit; and
a second scan signal line driving circuit,
wherein of all scan signal lines consisting of (i) a first group of scan signal lines connected to the first scan signal line driving circuit and (ii) a second group of scan signal lines connected to the second scan signal line driving circuit, the scan signal lines in the first group and the scan signal lines in the second group are disposed in an alternate manner,
the first scan signal line driving circuit including a first shift register which receives two clock signals that are first and second clock signals,
the first shift register having stages each of which includes first and second clock input terminals,
the first shift register being arranged to have first stages and second stages alternately cascaded with each other, each of the first stages being such that the first clock signal is supplied to the first clock input terminal, and the second clock signal is supplied to the second clock input terminal, each of the second stages being such that the second clock signal is supplied to the first clock input terminal, and the first clock signal is supplied to the second clock input terminal,
the stages of the first shift register, upon receipt of a shift pulse from a preceding stage, each outputting a scan pulse by transferring a clock pulse of a clock signal supplied through the first clock input terminal to a scan signal line corresponding to the individual stage,
the stages of the first shift register each including a first transistor that is provided so as to connect and disconnect a scan signal line corresponding to the individual stage to and from a low-level power source of the scan pulse, the first transistor having a gate receiving a clock signal supplied through the second clock input terminal,
the second scan signal line driving circuit including a second shift register which receives two clock signals that are third and fourth clock signals,
the second shift register having stages each of which includes third and fourth clock input terminals,
the second shift register being arranged to have third stages and fourth stages alternately cascaded with each other, each of the third stages being such that the third clock signal is supplied to the third clock input terminal, and the fourth clock signal is supplied to the fourth clock input terminal, each of the fourth stages being such that the fourth clock signal is supplied to the third clock input terminal, and the third clock signal is supplied to the fourth clock input terminal,
the stages of the second shift register, upon receipt of a shift pulse from a preceding stage, each outputting a scan pulse by transferring a clock pulse of a clock signal supplied through the third clock input terminal to a scan signal line corresponding to the individual stage,
the stages of the second shift register each including a second transistor that is provided so as to connect and disconnect a scan signal line corresponding to the individual stage to and from a low-level power source of the scan pulse, the second transistor having a gate receiving a clock signal supplied through the fourth clock input terminal,
wherein timings for the first clock signal, the second clock signal, the third clock signal, and the fourth clock signal are such that a clock pulse of the first clock signal appears subsequently to a clock pulse of the fourth clock signal, a clock pulse of the third clock signal appears subsequently to a clock pulse of the first clock signal, a clock pulse of the second clock signal appears subsequently to the clock pulse of the third clock signal, and the clock pulse of the fourth clock signal appears subsequently to the clock pulse of the second clock signal.

2. A display device comprising an active matrix panel,
the display device further comprising:
a first scan signal line driving circuit; and
a second scan signal line driving circuit,
wherein of all scan signal lines consisting of (i) a first group of scan signal lines connected to the first scan signal line driving circuit and (ii) a second group of scan signal lines connected to the second scan signal line driving circuit, the scan signal lines in the first group and the scan signal lines in the second group are disposed in an alternate manner,
the first scan signal line driving circuit including a first shift register which receives four clock signals that are first, second, and third, fourth clock signals,
the first shift register having stages each of which includes first, second, third, and fourth clock input terminals,
the first shift register being arranged to have first stages and second stages alternately cascaded with each other, each of the first stages being such that the first clock signal is supplied to the first clock input terminal, the second clock signal is supplied to the second clock input terminal, the third clock signal is supplied to the third clock input terminal, and the fourth clock signal is supplied to the fourth clock input terminal, each of the second stages being such that the second clock signal is supplied to the first clock input terminal, the first clock signal is supplied to the second clock input terminal, the fourth clock signal is supplied to the third clock input terminal, and the third clock signal is supplied to the fourth clock input terminal,
the stages of the first shift register, upon receipt of a shift pulse from a preceding stage, each outputting a scan pulse by transferring a clock pulse, of a clock signal supplied through the first clock input terminal to a scan signal line corresponding to the individual stage,
the stages of the first shift register each including: a first transistor that is provided so as to connect and disconnect a scan signal line corresponding to the individual stage to and from a low-level power source of the scan pulse, the first transistor having a gate receiving a clock signal supplied through the second clock input terminal; a second transistor that is provided so as to connect and disconnect the scan signal line corresponding to the individual stage to and from the low-level power source, the second transistor having a gate to which a clock pulse of a clock signal supplied through the third clock input terminal is applied; and a third transistor that is provided so as to connect and disconnect the scan signal line corresponding to the individual stage to and from the low-level power source, the third transistor having a gate to which a clock pulse of a clock signal supplied through the fourth clock input terminal is applied,
the second scan signal line driving circuit including a second shift register which receives the four clock signals that are the first, second, and third, fourth clock signals,
the second shift register having stages each of which includes fifth, sixth, seventh, and eighth clock input terminals,
the second shift register being arranged to have third stages and fourth stages alternately cascaded with each other, each of the third stages being such that the third clock signal is supplied to the fifth clock input terminal, the fourth clock signal is supplied to the sixth clock input terminal, the first clock signal is supplied to the seventh clock input terminal, and the second clock signal is supplied to the eighth clock input terminal, each of the fourth stages being such that the fourth clock signal is supplied to the fifth clock input terminal, the third clock signal is supplied to the sixth clock input terminal, the second clock signal is supplied to the seventh clock input terminal, and the first clock signal is supplied to the eighth clock input terminal,
the stages of the second shift register, upon receipt of a shift pulse from a preceding stage, each outputting a scan pulse by transferring a clock pulse of a clock signal supplied through the fifth clock input terminal to a scan signal line corresponding to the individual stage,
the stages of the second shift register each including: a fourth transistor that is provided so as to connect and disconnect a scan signal line corresponding to the individual stage to and from a low-level power source of the scan pulse, the fourth transistor having a gate receiving a clock signal supplied through the sixth clock input terminal; a fifth transistor that is provided so as to connect and disconnect the scan signal line corresponding to the individual stage to and from the low-level power source, the fifth transistor having a gate to which a clock pulse of a clock signal supplied through the seventh clock input terminal is applied; and a sixth transistor that is provided so as to connect and disconnect the scan signal line corresponding to the individual stage to and from the low-level power source, the sixth transistor having a gate to which a clock pulse of a clock signal supplied through the eighth clock input terminal is applied,
wherein timings for the first clock signal, the second clock signal, the third clock signal, and the fourth clock signal are such that a clock pulse of the first clock signal appears subsequently to a clock pulse of the fourth clock signal, a clock pulse of the third clock signal appears subsequently to a clock pulse of the first clock signal, a clock pulse of the second clock signal appears subsequently to the clock pulse of the third clock signal, and the clock pulse of the fourth clock signal appears subsequently to the clock pulse of the second clock signal.

3. The display device according to claim 1, wherein
one of the first and second scan signal line drive circuits is provided in one of two regions adjoining a display region of the panel in a direction in which the scan signal lines extend, and
the other scan signal line drive circuit is provided in the other region adjoining the display region of the panel.

4. A display device comprising an active matrix panel,
the display device further comprising a scan signal line driving circuit that is provided in a region adjoining a display region of the panel in a direction in which scan signal lines extend and that includes first and second shift registers connected to the scan signal lines,
wherein of all of the scan signal lines consisting of (i) a first group of scan signal lines connected to the first shift register and (ii) a second group of scan signal lines connected to the second shift register, the scan signal lines in the first group and the scan signal lines in the second group are disposed in an alternate manner,
the first shift register receiving two clock signals that are first and second clock signals,
the first shift register having stages each of which includes first and second clock input terminals,
the first shift register being arranged to have first stages and second stages alternately cascaded with each other, each of the first stages being such that the first clock signal is supplied to the first clock input terminal, and the second clock signal is supplied to the second clock input terminal, each of the second stages being such that the second clock signal is supplied to the first clock input terminal, and the first clock signal is supplied to the second clock input terminal,
the stages of the first shift register, upon receipt of a shift pulse from a preceding stage, each outputting a scan pulse by transferring a clock pulse of a clock signal supplied through the first clock input terminal to a scan signal line corresponding to the individual stage,
the stages of the first shift register each including a first transistor that is provided so as to connect and disconnect a scan signal line corresponding to the individual stage to and from a low-level power source of the scan pulse, the first transistor having a gate receiving a clock signal supplied through the second clock input terminal,
the second shift register receiving two clock signals that are third and fourth clock signals,
the second shift register having stages each of which includes third and fourth clock input terminals,
the second shift register being arranged to have third stages and fourth stages alternately cascaded with each other, each of the third stages being such that the third clock signal is supplied to the third clock input terminal and that the fourth clock signal is supplied to the fourth clock input terminal, each of the fourth stages being such that the fourth clock signal is supplied to the third clock input terminal and that the third clock signal is supplied to the fourth clock input terminal,
the stages of the second shift register, upon receipt of a shift pulse from a preceding stage, each outputting a scan pulse by transferring a clock pulse of a clock signal supplied through the third clock input terminal to a scan signal line corresponding to the individual stage,
the stages of the second shift register each including a second transistor that is provided so as to connect and disconnect a scan signal line corresponding to the individual stage to and from a low-level power source of the scan pulse, the second transistor having a gate receiving a clock signal supplied through the fourth clock input terminal,
wherein timings for the first clock signal, the second clock signal, the third clock signal, and the fourth clock signal are such that a clock pulse of the first clock signal appears subsequently to a clock pulse of the fourth clock signal, a clock pulse of the third clock signal appears subsequently to a clock pulse of the first clock signal, a clock pulse of the second clock signal appears subsequently to the clock pulse of the third clock signal, and the clock pulse of the fourth clock signal appears subsequently to the clock pulse of the second clock signal.

5. The display device according to claim 1, wherein
the first and second scan signal line drive circuits are monolithically formed in the panel.

6. The display device according to claim 4, wherein
the scan signal line drive circuit is monolithically formed in the panel.

7. The display device according to claim 5, wherein
the panel is formed from amorphous silicon.

8. The display device according to claim 5, wherein
the panel is formed from polycrystalline silicon.

9. The display device according to claim 5, wherein
the panel is formed from CG silicon.

10. The display device according to claim 5, wherein
the panel is formed from microcrystalline silicon.

11. A method for driving a display device comprising an active matrix panel,
the display device further comprising:
a first scan signal line driving circuit including a first shift register; and
a second scan signal line driving circuit including a second shift register,
wherein of all scan signal lines consisting of (i) a first group of scan signal lines connected to the first scan signal line driving circuit and (ii) a second group of scan signal lines connected to the second scan signal line driving circuit, the scan signal lines in the first group and the scan signal lines in the second group are disposed in an alternate manner,
the method comprising:
supplying two clock signals that are first and second clock signals to each of stages of the first shift register;
causing the stages of the first shift register to operate so that first stages and second stages are alternately arranged, each of the first stages operating to, upon receipt of a shift pulse from a preceding stage, output a scan pulse by transferring a clock pulse of the first clock signal to a scan signal line corresponding to the individual stage, each of the second stages operating to, upon receipt of a shift pulse from a preceding stage, output a scan pulse by transferring a clock pulse of the second clock signal to a scan signal line corresponding to the individual stage;
causing each of the first stages to connect and disconnect a scan signal line corresponding to the individual stage to and from a low-level power source of the scan pulse, when the second clock signal is supplied to a gate of a transistor provided in each of the first stages;
causing each of the second stages to connect and disconnect a scan signal line corresponding to the individual stage to and from a low-level power source of the scan pulse, when the first clock signal is supplied to a gate of a transistor provided in each of the second stages;
supplying two clock signals that are third and fourth clock signals to each of stages of the second shift register;
causing the stages of the second shift register to operate so that third stages and fourth stages are alternately arranged, each of the third stages operating to, upon receipt of a shift pulse from a preceding stage, output a scan pulse by transferring a clock pulse of the third clock signal to a scan signal line corresponding to the individual stage, each of the fourth stages operating to, upon receipt of a shift pulse from a preceding stage, output a scan pulse by transferring a clock pulse of the fourth clock signal to a scan signal line corresponding to the individual stage;
causing each of the third stages to connect and disconnect a scan signal line corresponding to the individual stage to and from a low-level power source of the scan pulse, when the fourth clock signal is supplied to a gate of a transistor provided in each of the third stages; and
causing each of the fourth stages to connect and disconnect a scan signal line corresponding to the individual stage to and from a low-level power source of the scan pulse, when the third clock signal is supplied to a gate of a transistor provided in each of the fourth stages,
wherein timings for the first clock signal, the second clock signal, the third clock signal, and the fourth clock signal are such that the clock pulse of the first clock signal appears subsequently to the clock pulse of the fourth clock signal, the clock pulse of the third clock signal appears subsequently to the clock pulse of the first clock signal, the clock pulse of the second clock signal appears subsequently to the clock pulse of the third clock signal, and the clock pulse of the fourth clock signal appears subsequently to the clock pulse of the second clock signal.

12. A method for driving a display device comprising an active matrix panel,
the display device further comprising:
a first scan signal line driving circuit including a first shift register; and
a second scan signal line driving circuit including a second shift register,
wherein of all scan signal lines consisting of (i) a first group of scan signal lines connected to the first scan signal line driving circuit and (ii) a second group of scan signal lines connected to the second scan signal line driving circuit, the scan signal lines in the first group and the scan signal lines in the second group are disposed in an alternate manner,
the method comprising:
supplying four clock signals that are first, second, third, and fourth clock signals to each of stages of the first shift register;
causing the stages of the first shift register to operate so that first stages and second stages are alternately arranged, each of the first stages operating to, upon receipt of a shift pulse from a preceding stage, output a scan pulse by transferring a clock pulse of the first clock signal to a scan signal line corresponding to the individual stage, each of the second stages operating to, upon receipt of a shift pulse from a preceding stage, output a scan pulse by transferring a clock pulse of the second clock signal to a scan signal line corresponding to the individual stage;
causing each of the first stages to connect and disconnect a scan signal line corresponding to the individual stage to and from a low-level power source of the scan pulse, when the second, third, or fourth clock signal is supplied to each gate of three transistors provided in each of the first stages;
causing each of the second stages to connect and disconnect a scan signal line corresponding to the individual stage to and from a low-level power source of the scan pulse, when the first, third, or fourth clock signal is supplied to each gate of three transistors provided in each of the second stages;
supplying four clock signals that are the first, second, third, and fourth clock signals to each of stages of the second shift register;
causing the stages of the second shift register to operate so that third stages and fourth stages are alternately arranged, each of the third stages operating to, upon receipt of a shift pulse from a preceding stage, output a scan pulse by transferring a clock pulse of the third clock signal to a scan signal line corresponding to the individual stage, each of the fourth stages operating to, upon receipt of a shift pulse from a preceding stage, output a scan pulse by transferring a clock pulse of the fourth clock signal to a scan signal line corresponding to the individual stage;
causing each of the third stages to connect and disconnect a scan signal line corresponding to the individual stage to and from a low-level power source of the scan pulse, when the first, second, or fourth clock signal is supplied to each gate of three transistors provided in each of the third stages; and
causing each of the fourth stages to connect and disconnect a scan signal line corresponding to the individual stage to and from a low-level power source of the scan pulse, when the first, second, or third clock signal is supplied to each gate of three transistors provided in each of the fourth stages,
wherein timings for the first clock signal, the second clock signal, the third clock signal, and the fourth clock signal are such that the clock pulse of the first clock signal appears subsequently to the clock pulse of the fourth clock signal, the clock pulse of the third clock signal appears subsequently to the clock pulse of the first clock signal, the clock pulse of the second clock signal appears subsequently to the clock pulse of the third clock signal, and the clock pulse of the fourth clock signal appears subsequently to the clock pulse of the second clock signal.

13. The display device according to claim 11, wherein
one of the first and second scan signal line drive circuits is provided in one of two regions adjoining a display region of the panel in a direction in which the scan signal lines extend, and
the other scan signal line drive circuit is provided in the other region adjoining the display region of the panel.

14. A method for driving a display device comprising an active matrix panel,
the display device further comprising a scan signal line driving circuit that is provided in a region adjoining a display region of the panel in a direction in which scan signal lines extend and that includes first and second shift registers connected to the scan signal lines,
wherein of all of the scan signal lines consisting of (i) a first group of scan signal lines connected to the first shift register and (ii) a second group of scan signal lines connected to the second shift register, the scan signal lines in the first group and the scan signal lines in the second group are disposed in an alternate manner,
the method comprising:
supplying two clock signals that are first and second clock signals to each of stages of the first shift register;
causing the stages of the first shift register to operate so that first stages and second stages are alternately arranged, each of the first stages operating to, upon receipt of a shift pulse from a preceding stage, output a scan pulse by transferring a clock pulse of the first clock signal to a scan signal line corresponding to the individual stage, each of the second stages operating to, upon receipt of a shift pulse from a preceding stage, output a scan pulse by transferring a clock pulse of the second clock signal to a scan signal line corresponding to the individual stage;
causing each of the first stages to connect and disconnect a scan signal line corresponding to the individual stage to and from a low-level power source of the scan pulse, when the second clock signal is supplied to a gate of a transistor provided in each of the first stages;
causing each of the second stages to connect and disconnect a scan signal line corresponding to the individual stage to and from a low-level power source of the scan pulse, when the first clock signal is supplied to a gate of a transistor provided in each of the second stages;
supplying two clock signals that are third and fourth clock signals to each of stages of the second shift register;
causing the stages of the second shift register to operate so that third stages and fourth stages are alternately arranged, each of the third stages operating to, upon receipt of a shift pulse from a preceding stage, output a scan pulse by transferring a clock pulse of the third clock signal to a scan signal line corresponding to the individual stage, each of the fourth stages operating to, upon receipt of a shift pulse from a preceding stage, output a scan pulse by transferring a clock pulse of the fourth clock signal to a scan signal line corresponding to the individual stage;
causing each of the third stages to connect and disconnect a scan signal line corresponding to the individual stage to and from a low-level power source of the scan pulse, when the fourth clock signal is supplied to a gate of a transistor provided in each of the third stages; and
causing each of the fourth stages to connect and disconnect a scan signal line corresponding to the individual stage to and from a low-level power source of the scan pulse, when the third clock signal is supplied to a gate of a transistor provided in each of the fourth stages,
wherein timings for the first clock signal, the second clock signal, the third clock signal, and the fourth clock signal are such that the clock pulse of the first clock signal appears subsequently to the clock pulse of the fourth clock signal, the clock pulse of the third clock signal appears subsequently to the clock pulse of the first clock signal, the clock pulse of the second clock signal appears subsequently to the clock pulse of the third clock signal, and the clock pulse of the fourth clock signal appears subsequently to the clock pulse of the second clock signal.

15. The method according to claim 11, wherein
the first and second scan signal line drive circuits are monolithically formed in the panel.

16. The method according to claim 14, wherein
the scan signal line drive circuit is monolithically formed in the panel.

17. The method according to claim 15, wherein
the panel is formed from amorphous silicon.

18. The method according to claim 15, wherein
the panel is formed from polycrystalline silicon.
